(19) United States
(12) Patent Application Publication
(10) Pub. No.: US 2022/0335209 A1
(43) Pub. Date: Oct. 20, 2022

(54) SYSTEMS, APPARATUS, ARTICLES OF MANUFACTURE, AND METHODS TO GENERATE DIGITIZED HANDWRITING WITH USER STYLE ADAPTATIONS

(71) Applicants: Chia-Hung S. Kuo, Folsom, CA (US); Sherine Abdelhak, Beaverton, OR (US); Tamoghna Ghosh, Bangalore (IN); Vijayalaxmi Patil, Bangalore (IN)

(72) Inventors: Chia-Hung S. Kuo, Folsom, CA (US); Sherine Abdelhak, Beaverton, OR (US); Tamoghna Ghosh, Bangalore (IN); Vijayalaxmi Patil, Bangalore (IN)

(21) Appl. No.: 17/850,512

(22) Filed: Jun. 27, 2022

(51) Int. Cl. G06F 40/166; G06N 20/00

(52) U.S. Cl. CPC G06F 40/166; G06N 20/00

(57) ABSTRACT

Systems, apparatus, articles of manufacture, and methods to generate digitized handwriting with user style adaptations are disclosed. An example apparatus includes at least one memory, and processor circuitry to train a machine learning model to generate a first digitized handwriting sequence based on a stored handwriting sample. To train the machine learning model, the processor circuitry is to cause a parameterization of a first portion of the machine learning model; and cause a reparameterization of a second portion of the machine learning model. The processor circuitry to re-train the trained machine learning model to generate a second digitized handwriting sequence based on a user handwriting sample.

### FIELD OF THE DISCLOSURE

This disclosure relates generally to machine learning and, more particularly, to systems, apparatus, articles of manufacture, and methods to generate digitized handwriting with user style adaptations.

### BACKGROUND

Handwriting style of every person is unique and reflects traits about their personality and their engagement with the subject matter. Handwriting has distinct advantages over typing in some respects, such as increased flexibility, especially in mathematical and/or chemical equations, better retention of the subject matter, and increased opportunity for creativity. As such, handwriting remains important today—even in digital settings.

### BRIEF DESCRIPTION OF THE DRAWINGS

FIG. 1 is an illustration of an example electronic system including example handwriting generation circuitry.

FIG. 2 is a block diagram of an example implementation of the example handwriting generation circuitry of FIG. 1.

FIG. 3 is an illustration of an example handwriting generation model architecture associated with the example handwriting generation circuitry of FIGS. 1 and 2.

FIG. 4 is an illustration of another example handwriting generation model architecture associated with the example handwriting generation circuitry of FIGS. 1-3.

FIG. 5 is a flowchart representative of example machine readable instructions and/or example operations that may be executed by example processor circuitry to implement the example handwriting generation circuitry of FIGS. 1-4 to train the example handwriting generation model of FIGS. 3 and/or 4.

FIG. 6 is a flowchart representative of example machine readable instructions and/or example operations that may be executed by example processor circuitry to implement the example handwriting generation circuitry of FIGS. 1-4 to adapt the example handwriting generation model of FIGS. 3 and/or 4 to new or additional authors.

FIG. 7 is a flowchart representative of example machine readable instructions and/or example operations that may be executed by example processor circuitry to implement the example handwriting generation circuitry of FIGS. 1-4 to execute the example handwriting generation model of FIGS. 3 and/or 4 to generate digitized handwriting.

FIG. 8 is a flowchart representative of example machine readable instructions and/or example operations that may be executed by example processor circuitry to implement the example handwriting generation circuitry of FIGS. 1-4 to evaluate digitized handwriting generated using the example handwriting generation model of FIGS. 3 and/or 4.

FIGS. 9A-D are illustrations of example improvements of generating digitized handwriting with examples disclosed herein with respect to conventional handwriting generation techniques.

FIG. 10 is a block diagram of an example processing platform including processor circuitry structured to execute the example machine readable instructions and/or the example operations of FIGS. 5-8 to implement the example handwriting generation circuitry of FIGS. 1-4.

FIG. 11 is a block diagram of an example implementation of the processor circuitry of FIG. 10.

FIG. 12 is a block diagram of another example implementation of the processor circuitry of FIG. 10.

FIG. 13 is a block diagram of an example software distribution platform (e.g., one or more servers) to distribute software (e.g., software corresponding to the example machine readable instructions of FIGS. 5-8) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

Although digital interactions have become widely adopted in many fields, handwriting has remained prevalent for users as a result of, for example, increased flexibility provided by handwriting compared to typing, improved haptic perception that results from handwriting, improved recollection of content that is handwritten, and improved creativity enabled by handwriting. However, utilizing handwriting in digital settings (e.g., settings that utilize computing devices) presents difficulties that can make handwriting less convenient than typing. For instance, handwritten content cannot be searched for keywords with the press of a button(s) (e.g., CTRL+F). Further, after being scanned by a computing device, the handwriting cannot be edited and occupies significant storage space. As such, users in digital settings often do not experience the benefits of handwriting as a result of the inconveniences associated with utilizing handwritten content in the digital settings.

To enable handwriting usage to increase, adapt to, and improve with digital settings, artificial intelligence and/or machine learning (AI/ML) may be utilized for handwriting generation. Machine learning models, such as neural networks (e.g., artificial neural networks (ANNs), convolutional neural networks (CNNs), deep neural networks (DNNs), etc.) are useful tools that have demonstrated value in solving complex problems, such as handwriting recognition. Neural networks operate, for example, by using artificial neurons arranged into layers that process data from an input layer to an output layer and apply weighting values to the data during processing of the data. Such weighting values are determined during a training process. For instance, typical DNN architectures have learnable parameters that are stacked using complex network topologies, which gives them improved ability to fit training data with respect to other types of AI/ML techniques.

In some known handwriting generation techniques, generative adversarial networks (GANs) are utilized for handwriting image generation. However, with generated images, the handwritten content occupies substantial storage space and remains unsearchable and inflexible with respect to editing. Moreover, such techniques do not enable adaptations to a custom style displayed in handwritten content from a user.

In some other known handwriting generation techniques, handwriting ink coordinates are generated. However, the generated handwriting often fails to accurately reflect the particular style of the user, which can impair the haptic perception associated with the handwriting when viewed by the user. Additionally, such techniques have demonstrated an inability to adapt to cursive handwriting. Furthermore, with such techniques, the generated handwriting often has an uptrend or a downtrend from horizontal (e.g., or a left-trend/right-trend from vertical), which can cause interference between lines of handwriting and causes the handwriting to be difficult for a user or other reader to follow. Accordingly, the detriments of known handwriting generation techniques limit the utilization of handwriting in digital settings.

Examples disclosed herein provide systems, apparatus, articles of manufacture, and methods to generate digitized handwriting with user style adaptations. Examples disclosed herein generate digitized handwriting using a recurrent neural network model that is adaptable to a style displayed by a user when provided a relatively small handwriting sample (e.g., less than twenty (20) handwritten words and/or symbols) from the user. Examples disclosed herein train the recurrent neural network model to generate generalized handwriting styles based on one or more online dataset(s). Furthermore, examples disclosed herein re-train the recurrent neural network model to adapt to the style displayed by any user using few-shot learning.

In disclosed examples, the recurrent neural network model includes an attention layer, a sequence generator network including one or more long short-term memories (LSTMs), a mixture density network (MDN) layer, and a reparameterization layer. The example attention layer indicates what text is to be generated. For example, the attention layer can guide the model to generate identified characters (e.g., letters, numbers, symbols, etc.) in a certain style. Furthermore, the example sequence generator can include three (3) layers of stacked LSTMs to generate handwriting coordinate sequences with attention. In turn, the MDN can learn a distribution of the generated handwriting coordinates based on the character being generated and/or the style in which the character is to be presented. The example reparameterization layer performs a comparison between an original handwriting sequence and the generated handwriting sequence and, in turn, modifies weighting values and/or connections in the MDN layer and/or the LSTM(s) to reduce (i.e., minimize) an error based on the comparison.

In disclosed examples, the reparameterization layer analyzes two types of differences between the original handwriting sequence and the generated handwriting sequence: mixture density network loss (MDN loss) and mean squared error (MSE). In particular, with the MDN loss, the reparameterization layer can analyze the generated coordinate distribution, which relates to the handwriting style. In other words, the MDN loss enables the reparameterization layer to evaluate the performance of the MDN layer by comparing a distribution of digital ink coordinates for a generated character to a geometry of ink defining the character in the original handwriting sequence. Furthermore, with the MSE, the reparameterization layer can analyze an average deviation of the generated handwriting sequence relative to the original handwriting sequence. In particular, using the MSE enables the reparameterization layer to analyze coordinates of the generated digital ink relative to coordinates of the ink in the original handwriting sequence. As a result, the MSE enables the reparameterization layer to detect deviations in an alignment of the generated handwriting sequence relative to the original handwriting sequence. As such, the reparameterization layer can detect an uptrend, a downtrend, a left-trend, and/or a right-trend in the generated handwriting sequence and, in turn, cause modifications in the MDN layer and/or the LSTM(s) to enable the digital ink in the generated handwriting sequence to be pixel-exact or near pixel-exact. Advantageously, the reparameterization layer causes the recurrent neural network to generate more realistic handwriting, whereas existing techniques smoothen generated words, which causes the generated words to appear different from a style with which the words were written.

In response to training the recurrent neural network model to generate generalized handwriting styles based on one or more online dataset(s), examples disclosed herein re-train the recurrent neural network to adopt a writing style of a given user using few gradient descent steps. In particular, to adapt to the writing style of the user, examples disclosed herein utilize few-shot learning. Few-shot learning is an optimization-based model-agnostic meta-learning (MAML) technique that learns via gradient descent. Specifically, examples disclosed herein fix (e.g., maintain, lock, etc.) the LSTM layers after the initial training period but re-train the MDN layer using MAML techniques and running a few gradient descent steps with a small data sample (e.g., twenty or fewer words, numbers and/or symbols in a handwritten sequence) from the user. In examples disclosed herein, hyperparameters for the user-specific training are set (e.g., empirically selected) to account for learning rate, batch size, number of training steps, etc.

During a user-specific training period, examples disclosed herein can access handwriting of a user via writing on a touch screen, a scanned or downloaded image, etc. and provide the handwriting to the recurrent neural network. At this point, the LSTM layers of the recurrent neural network are fixed such that the MDN layer can learn to reflect the style of the handwriting presented by the user using few-shot learning. For example, using few-shot learning, the selected hyperparameters, and the reparameterization layer, the MDN layer can adapt connections and/or weights to reduce (i.e., minimize) an error between handwriting vectors outputted by the MDN layer and an initial set of words, numbers, and/or symbols written by the user. In some examples, the MDN layer trains in substantially real time (e.g., as the user writes user-specific training data on the touch screen).

In turn, examples disclosed herein can execute the recurrent neural network with the adapted MDN layer for usage with any subsequent writing from the user to cause the writing to be digitized in substantially real time. In some examples, the recurrent neural network model outputs the digitized handwriting as vectors in a compressed scalable vector graphics format (e.g., an SVGZ format) to reduce the storage space occupied by the digitized handwriting and enable the digitized writing to scale to any format. To enable different models to be generated for different users, examples disclosed herein may maintain a generalized version of the recurrent neural network model in response to performing the initial training such that the generalized version of the recurrent neural network model can be utilized as a starting point for any new and/or additional user models and/or adaptations.

Advantageously, examples disclosed herein generate digitized handwriting that is adaptable to a handwriting style presented by the user with a small sample size (e.g., twenty or fewer handwritten words and/or numbers). Furthermore, by comparing the generated and original handwriting sequences with both the MDN loss and the MSE loss, the example reparameterization layer can help train the LSTM layers and/or the MDN layer to account for handwriting style (e.g., digital ink coordinate distribution) as well as position (e.g., digital ink pixel location). As such, examples disclosed herein are able to capture cursive styles commonly missed with known techniques. Additionally, examples disclosed herein are able to maintain an alignment of a handwritten sequence such that an organization of the handwriting can be preserved as adjacent rows or columns in the generated handwriting do not overlap. Thus, examples disclosed herein generate author-specific digitized handwriting that is searchable, editable, and scalable to improve flexibility, efficiency, retention, and/or collaboration in digital settings.

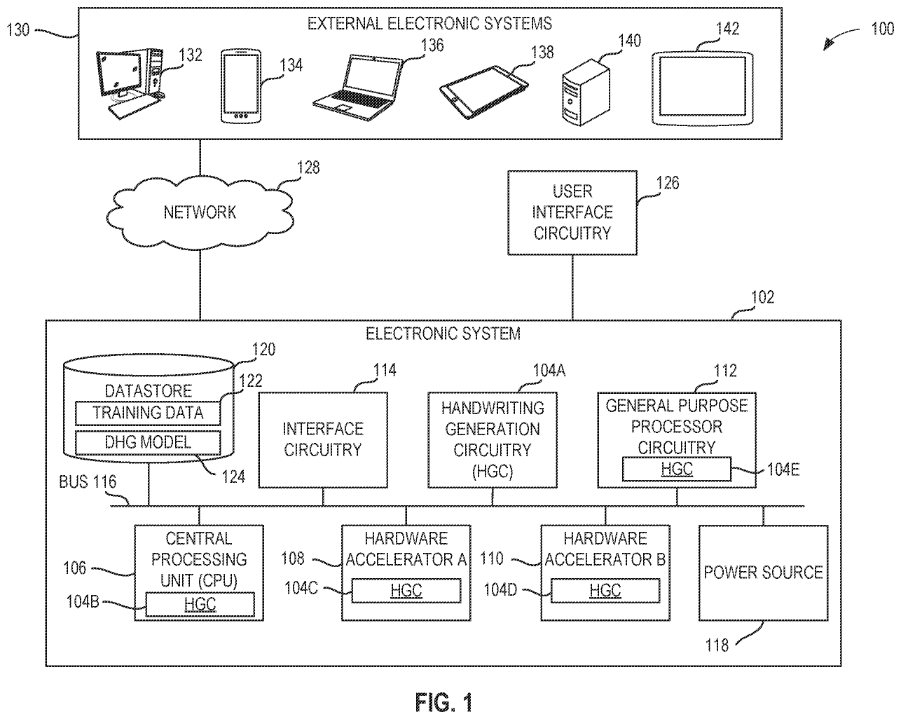

FIG. 1 is an illustration of an example computing environment 100 including an example electronic system 102, which includes example handwriting generation circuitry (HGC) 104A-E to effectuate training and deployment of one or more machine learning model(s) that generate digitized handwriting with author-specific style adaptations in accordance with examples disclosed herein. The electronic system 102 of the illustrated example of FIG. 1 includes an example central processing unit (CPU) 106, a first example hardware accelerator (identified by HARDWARE ACCELERATOR A) 108, a second example hardware accelerator (identified by HARDWARE ACCELERATOR B) 110, example general purpose processor circuitry 112, example interface circuitry 114, an example bus 116, an example power source 118, and an example datastore 120. The datastore 120 of the illustrated example of FIG. 1 includes example training data 122 and an example digitized handwriting generation model (DHG MODEL) 124. Additionally and/or alternatively, the datastore 120 may store any number and/or type(s) of digitized handwriting generation models. For example, the datastore 120 can store a first digitized handwriting generation model for a first user, a second digitized handwriting generation model for a second user, and a third digitized handwriting generation model (e.g., a parent digitized handwriting generation model) that can be adapted to suit a handwriting style of a user not yet encountered. Further depicted in the illustrated example of FIG. 1 is example user interface circuitry 126, an example network 128, and example external electronic systems 130.

In the illustrated example of FIG. 1, the electronic system 102 is a combination of hardware, software, and/or firmware (e.g., a computing device) on which the DHG model 124 is to be trained, deployed, instantiated, and/or executed. In some examples, the electronic system 102 is a mobile device, such as a cell or mobile phone (e.g., an Internet-enabled smartphone), a tablet computer (e.g., an Internet-enabled tablet), etc. For example, the electronic system 102 can be implemented as a mobile phone having one or more processors (e.g., a CPU, a digital signal processor (DSP), a graphics processing unit (GPU), a vision processing unit (VPU), an artificial intelligence (AI) and/or neural-network (NN) specific processor, etc.) on one or more system-on-a-chip (SoC) substrates. In some examples, the electronic system 102 is a desktop computer, a laptop computer, an interactive whiteboard (e.g., a smart board), a server, etc. For example, the electronic system 102 can be implemented as a desktop computer, a laptop computer, an interactive whiteboard (e.g., a smart board), a server, etc., having one or more processors (e.g., a CPU, a GPU, a VPU, an AI/NN specific processor, etc.) on one or more SoCs.

In some examples, the electronic system 102 is an SoC representative of one or more integrated circuits (ICs) (e.g., compact ICs) that incorporate components of a computer or other electronic system in a compact format. For example, the electronic system 102 may be implemented with a combination of one or more programmable processors, hardware logic, and/or hardware peripherals and/or interfaces. Additionally or alternatively, the example electronic system 102 of FIG. 1 may include memory, input/output (I/O) port(s), and/or secondary storage. For example, the electronic system 102 includes the handwriting generation circuitry 104A-E, the CPU 106, the first hardware accelerator 108, the second hardware accelerator 110, the general purpose processor circuitry 112, the interface circuitry 114, the bus 116, the power source 118, the datastore 120, the memory, the I/O port(s), and/or the secondary storage all on the same substrate. In some examples, the electronic system 102 includes digital, analog, mixed-signal, radio frequency (RF), or other signal processing functions.

In some examples, the first hardware accelerator 108 of the illustrated example of FIG. 1 is a GPU. For example, the first hardware accelerator 108 can be a GPU that generates computer graphics, executes general-purpose computing, etc. In some examples, the first hardware accelerator 108 processes AI/ML, tasks. For example, the first hardware accelerator 108 can execute and/or otherwise implement a neural network, such as an artificial neural network (ANN), a convolution neural network (CNN), a deep neural network (DNN), a recurrent neural network (RNN), etc.

In some examples, the second hardware accelerator 110 of the illustrated example of FIG. 1 is a VPU. For example, the second hardware accelerator 110 can effectuate machine or computer vision computing tasks. In some examples, the second hardware accelerator 110 can execute and/or otherwise implement a neural network, such as an ANN, a CNN, a DNN, an RNN, etc.

In some examples, the general purpose processor circuitry 112 of the illustrated example of FIG. 1 is a programmable processor, such as a CPU, a DSP, or a GPU. In some examples, the general purpose processor circuitry 112 completes AI/ML, tasks. For example, the general purpose processor circuitry 112 can execute and/or otherwise implement a neural network, such as an ANN, a CNN, a DNN, an RNN, etc. Additionally and/or alternatively, one or more of the CPU 106, the first hardware accelerator 108, the second hardware accelerator 110, and/or the general purpose processor circuitry 112 may be a different type of hardware such as a DSP, an application specific integrated circuit (ASIC), a programmable logic device (PLD), and/or a field programmable logic device (FPLD) (e.g., a field-programmable gate array (FPGA)).

In the illustrated example of FIG. 1, the interface circuitry 114 can be representative of and/or otherwise implement one or more interfaces. For example, the interface circuitry 114 can be implemented by a communication device (e.g., a network interface card (NIC), a smart NIC, an Infrastructure Processing Unit (IPU), etc.) such as a transmitter, a receiver, a transceiver, a modem, a residential gateway, a wireless access point, and/or a network interface to facilitate exchange of data with external machines (e.g., computing devices of any kind) via the network 128. In some examples, the communication is effectuated via an Ethernet connection, a digital subscriber line (DSL) connection, a telephone line connection, a coaxial cable system, a satellite system, a beyond line-of-site wireless system, a line-of-site wireless system, a cellular telephone system, etc. For example, the interface circuitry 114 can be implemented by any type of interface standard, such as a wireless fidelity (Wi-Fi) interface, an Ethernet interface, a universal serial bus (USB), a Bluetooth interface, a near field communication (NFC) interface, a Peripheral Component Interconnect (PCI) interface, and/or a Peripheral Component Interconnect express (PCI-e or PCIe) interface.

The electronic system 102 of the illustrated example includes the power source 118 to deliver power to portion(s) of the electronic system 102. In some examples, the power source 118 is a battery. For example, the power source 118 can be a limited-energy device, such as a lithium-ion battery or any other chargeable battery or power source. In some examples, the power source 118 is chargeable using a power adapter or converter (e.g., an alternating current (AC) to direct current (DC) power converter), a wall outlet (e.g., a 120V AC wall outlet, a 224V AC wall outlet, etc.), etc.

The electronic system 102 of the illustrated example of FIG. 1 includes the datastore 120 to record data (e.g., the training data 122, the DHG model 124, etc.). The datastore 120 of this example can be implemented by a volatile memory (e.g., a Synchronous Dynamic Random Access Memory (SDRAM), Dynamic Random Access Memory (DRAM), RAMBUS Dynamic Random Access Memory (RDRAM), etc.) and/or a non-volatile memory (e.g., flash memory). The datastore 120 may additionally and/or alternatively be implemented by one or more double data rate (DDR) memories, such as DDR, DDR2, DDR3, DDR4, DDR5, mobile DDR (mDDR), etc. The datastore 120 may additionally and/or alternatively be implemented by one or more mass storage devices such as hard disk drive(s) (HDD(s)), compact disk (CD) drive(s), digital versatile disk (DVD) drive(s), solid-state disk (SSD) drive(s), etc. While in the illustrated example the datastore 120 is illustrated as a single datastore, the datastore 120 may be implemented by any number and/or type(s) of datastores. Furthermore, the data stored in the datastore 120 may be in any data format such as, for example, binary data, comma delimited data, tab delimited data, structured query language (SQL) structures, image file formats (e.g., JPEG, PNG, TIFF, etc.), text formats, scalable vector graphics (SVG) structures, executable files (e.g., AI/ML executable files, AI/ML, configuration images, etc.).

In the illustrated example of FIG. 1, the datastore 120, and/or, more generally, the electronic system 102, stores the training data 122 to be used as model inputs for training the ML model 124. For example, the training data 122 can be any type of data, such as images (e.g., image data), text (e.g., text data), video clips (e.g., video data), labels (e.g., hard labels, soft labels, etc.), etc., and/or any combination thereof. In some examples, the training data 122 includes handwriting sequences from the IAM On-Line Handwriting Database and/or individual writers. Additionally or alternatively, the training data 122 can include other commercially available handwriting datasets. For example, the training data 122 can include respective datasets for different languages. In some examples, the training data 122 is temporarily accessed over network 128 and is not downloaded to the datastore 120.

In the illustrated example of FIG. 1, the datastore 120, and/or, more generally, the electronic system 102, stores the DHG model 124 to facilitate the training, deployment, and/or execution of the DHG model 124 on the electronic system 102 and/or one(s) of the external electronic systems 130. In this example, the DHG model 124 is a recurrent neural network model. In particular, the DHG model 124 includes an attention layer, a sequence generator implemented by at least one long short-term memory (LSTM) layer, a window layer, a mixture density network (MDN) layer, and a reparameterization layer.

In this example, the DHG model 124 is a machine learning model trained, deployed, instantiated, and executed by the handwriting generation circuitry 104A-E. For example, the handwriting generation circuitry 104A-E trains the DHG model 124 based on the training data 122. In particular, the handwriting generation circuitry 104A-E can cause the DHG model 124 to undergo initial training using a first portion of the training data 122 (e.g., the IAM On-Line Handwriting Database). In some examples, the first portion of the training data 122 is obtained from the network 128 via the interface circuitry 114. Further, the handwriting generation circuitry 104A-E can cause the DHG model to undergo user-specific training using a second portion of the training data 122 (e.g., twenty or fewer handwritten words and/or symbols from the user). In some examples, the second portion of the training data 122 is obtained via the interface circuitry 114 and/or the user interface circuitry 126.

After the initial and author-specific training, the handwriting generation circuitry 104A-E can execute the DHG model 124 to generate digitized handwriting in accordance with the handwriting style of a given user. Specifically, the handwriting generation circuitry 104A-E can execute the DHG model 124 to generate the digitized handwriting in a scalable vector graphics (e.g., SVG, SVGZ) format based on an input writing sequence (e.g., a handwritten sequence, text, etc.) obtained at, or indicated by, the user interface circuitry 126.

In the illustrated example of FIG. 1, the electronic system 102 is in communication with the user interface circuitry 126. In some examples, the user interface circuitry 126 is a graphical user interface (GUI), an application display, etc., presented to a user on a display device in circuit with and/or otherwise in communication with the electronic system 102 via one or more display interfaces (e.g., a Video Graphics Array (VGA) interface, a Digital Visual Interface (DVI), a High-Definition Multimedia Interface (HDMI), a DisplayPort interface, etc.). For example, the user interface circuitry 126 can be an interactive whiteboard, a touch screen, and/or any other device to obtain a writing input directly from a user. Additionally or alternatively, the user interface circuitry 126 can be a scanner, a camera, or any other system capable of capturing handwriting samples from a user in any format. In some examples, a user can control the electronic system 102, provide user-specific writing samples for the training data 122, etc., via the user interface circuitry 126. Additionally and/or alternatively, the electronic system 102 may include the user interface 126.

In the illustrated example of FIG. 1, the model training circuitry 104A-E, the CPU 106, the first hardware accelerator 108, the second hardware accelerator 110, the general purpose processor circuitry 112, the interface circuitry 114, the power source 118, and the datastore 120 are in communication with the bus 116. For example, the bus 116 can correspond to, be representative of, and/or otherwise implement at least one of an Inter-Integrated Circuit (I2C) bus, a Serial Peripheral Interface (SPI) bus, a PCI bus, or a PCIe bus.

In some examples, the network 128 of the illustrated example of FIG. 1 is the Internet. In some examples, the network 128 may be implemented using any suitable wired and/or wireless network(s) including, for example, one or more data buses, one or more Local Area Networks (LANs), one or more wireless LANs, one or more cellular networks, one or more private networks, one or more public networks, one or more satellite networks, etc. The network 128 can enable the electronic system 102 to be in communication with the external electronic systems 130.

In the illustrated example of FIG. 1, the external electronic systems 130 are devices (e.g., computing devices) on which the DHG model 124 can be executed. In this example, the external electronic systems 130 include an example desktop computer 132, an example mobile device (e.g., a smartphone, an Internet-enabled smartphone, etc.) 134, an example laptop computer 136, an example tablet (e.g., a tablet computer, an Internet-enabled tablet computer, etc.) 138, an example server 140, and an example interactive whiteboard 142. In some examples, fewer or more electronic systems than depicted in FIG. 1 may be used. Additionally and/or alternatively, the external electronic systems 130 may include, correspond to, and/or otherwise be representative of any other type of electronic device.

In some examples, one or more of the external electronic systems 130 execute the DHG model 124 to process a workload (e.g., an AI/ML workload, a computing workload, etc.). For example, the mobile device 134 can be implemented as a cellular or mobile phone having one or more processors (e.g., a CPU, a GPU, a VPU, an AI/NN specific processor, etc.) on one or more SoCs to process an AI/ML workload using the DHG model 124. For example, the desktop computer 132, the mobile device 134, the laptop computer 136, the tablet computer 138, the server 140, and/or the interactive whiteboard 142 can be implemented as electronic device(s) having one or more processors (e.g., a CPU, a GPU, a VPU, an AI/NN specific processor, etc.) on one or more SoCs to process an AI/ML workload using the DHG model 124. In some examples, the server 140 includes and/or otherwise is representative of one or more servers that can implement a central facility, a data facility, a cloud service (e.g., a public or private cloud provider, a cloud-based repository, etc.), a research institution (e.g., a laboratory, a research and development organization, a university, etc.), etc., to process AI/ML workload(s) using the DHG model 124.

In the illustrated example of FIG. 1, the electronic system 102 includes first handwriting generation circuitry 104A (e.g., a first instance of the handwriting generation circuitry 104A-E), second handwriting generation circuitry 104B (e.g., a second instance of the handwriting generation circuitry 104A-E), third handwriting generation circuitry 104C (e.g., a third instance of the handwriting generation circuitry 104A-E), fourth handwriting generation circuitry 104D (e.g., a fourth instance of the handwriting generation circuitry 104A-E), and fifth handwriting generation circuitry 104E (e.g., a fifth instance of the handwriting generation circuitry 104A-E) (collectively referred to herein as the handwriting generation circuitry 104A-E unless otherwise specified herein). In the illustrated example of FIG. 1, the first handwriting generation circuitry 104A can be implemented by hardware, software, and/or firmware. For example, the first handwriting generation circuitry 104A can be implemented by one or more analog or digital circuit(s), logic circuits, programmable processor(s), programmable controller(s), GPU(s), VPU(s), DSP(s), ASIC(s), PLD(s), FPLD(s), etc., and/or any combination(s) thereof.

In the illustrated example of FIG. 1, the second handwriting generation circuitry 104B is implemented by the CPU 106, the third handwriting generation circuitry 104C is implemented by the first hardware accelerator 108, the fourth handwriting generation circuitry 104D is implemented by the second hardware accelerator 110, and the fifth handwriting generation circuitry 104E is implemented by the general purpose processor circuitry 112. Additionally and/or alternatively, the first handwriting generation circuitry 104A, the second handwriting generation circuitry 104B, the third handwriting generation circuitry 104C, the fourth handwriting generation circuitry 104D, the fifth handwriting generation circuitry 104E, and/or portion(s) thereof, may be virtualized, such as by being implemented using one or more virtual machines (VMs), one or more containers, etc. Additionally and/or alternatively, the first handwriting generation circuitry 104A, the second handwriting generation circuitry 104B, the third handwriting generation circuitry 104C, the fourth handwriting generation circuitry 104D, and/or the fifth handwriting generation circuitry 104E may be implemented by different portion(s) of the electronic system 102, such as the first hardware accelerator 108, the second hardware accelerator 110, etc. Alternatively, the electronic system 102 may include one of the first handwriting generation circuitry 104A, the second handwriting generation circuitry 104B, the third handwriting generation circuitry 104C, the fourth handwriting generation circuitry 104D, and/or the fifth handwriting generation circuitry 104E. In some examples, the first handwriting generation circuitry 104A, the second handwriting generation circuitry 104B, the third handwriting generation circuitry 104C, the fourth handwriting generation circuitry 104D, and/or the fifth handwriting generation circuitry 104E can be implemented by the same hardware, software, and/or firmware to generate digitized handwriting with user-specific style adaptations.

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the handwriting generation circuitry 104A-E may train the DHG model 124 with data (e.g., the training data 122) to recognize patterns and/or associations and follow such patterns and/or associations when processing input data such that other input(s) result in output(s) consistent with the recognized patterns and/or associations.

Many different types of machine learning models and/or machine learning architectures exist. In examples disclosed herein, the handwriting generation circuitry 104A generates the DHG model 124 as a recurrent neural network and/or a deep neural network model. Using a deep neural network model enables feature generation automation and improved self-learning capabilities compared to classical machine learning models that require a degree of human intervention to determine the accuracy of an output. Furthermore, using a recurrent neural network model enables bi-directional data flow that propagates data from later processing stages to earlier processing stages. Using a neural network model enables the hardware accelerators 108, 110 to execute an AI/ML workload. In general, machine learning models/architectures/layers that are suitable to use in the example approaches disclosed herein will be a recurrent sequence model, long short-term memories (LSTMs), mixture density networks, reparameterization networks, and/or optimization-based model-agnostic meta-learning (MAML) (e.g., few-shot learning) models. However, other types of machine learning models could additionally or alternatively be used such as. Etc.

In general, implementing a ML/AI system involves two phases, a learning/training phase and an inference phase. In the learning/training phase, the handwriting generation circuitry 104A-E utilizes a general style training algorithm to train the DHG model 124 to operate in accordance with patterns and/or associations based on, for example, a first portion of the training data 122 obtained via the network 128. Further, in the learning/training phase, the handwriting generation circuitry 104A-E utilizes a user-adaptor algorithm to train the DHG model 124 to operate in accordance with patterns and/or associations based on, for example, a second portion of the training data 122 obtained via the user interface circuitry 126. In general, the DHG model 124 includes internal parameters (e.g., configuration data, weights, etc.) that guide how input data is transformed into output data, such as through a series of nodes and connections within the DHG model 124 to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, the handwriting generation circuitry 104A-E may invoke supervised training to use inputs and corresponding expected (e.g., labeled) outputs to select parameters (e.g., by iterating over combinations of select parameters) for the DHG model 124 that reduce model error. As used herein, “labelling” refers to an expected output of the machine learning model (e.g., a classification, an expected output value, etc.) Alternatively, the handwriting generation circuitry 104A-E may invoke unsupervised training (e.g., used in deep learning, a subset of machine learning, etc.) that involves inferring patterns from inputs to select parameters for the DHG model 124 (e.g., without the benefit of expected (e.g., labeled) outputs).

In examples disclosed herein, the handwriting generation circuitry 104A-E trains the DHG model 124 using stochastic gradient descent (e.g., few-shot learning), parameterization, and/or reparameterization. However, any other training algorithm may additionally or alternatively be used.

In examples disclosed herein, the handwriting generation circuitry 104A-E trains the DHG model 124 during an initial training period until an acceptable amount of error is achieved. For example, the handwriting generation circuitry 104A-E can train the DHG model 124 utilizing the first portion of the training data 122 until the level of error is no longer reducing. Further, in examples disclosed herein, the handwriting generation circuitry 104A-E further trains the DHG model 124 for a specific user until the level of error is no longer reducing using an initial writing sample from the user (e.g., twenty or fewer handwritten words, numbers, and/or symbols in sequence). As such, the handwriting generation circuitry 104A-E trains the DHG model 124 to adopt character and spacing patterns in the handwriting style presented by the individual user.

In examples disclosed herein, the handwriting generation circuitry 104A-E trains the DHG model 124 locally on the electronic system 102 and/or remotely at an external electronic system (e.g., one(s) of the external electronic systems 130) communicatively coupled to the electronic system 102. In some examples, the handwriting generation circuitry 104A-E causes an initial training of the DHG model 124 to be performed remotely, such as at the server 140, and causes user-specific training to be performed locally on the electronic system 102. In some examples, the handwriting generation circuitry 104A-E causes the initial training of the DHG model 124 to be performed at a first one of the external electronic systems 130, such as the server 140, and causes the user-specific training of the DHG model 124 to be performed at a second one of the external electronic systems, such as the interactive whiteboard 142. In some examples, the handwriting generation circuitry 104A-E causes the initial training and the user-specific training to be performed at the electronic system 102. In examples disclosed herein, the handwriting generation circuitry 104A-E trains the DHG model 124 using hyperparameters that control how the learning is performed (e.g., a learning rate, a batch size, a quantity of training steps, a number of layers to be used in the machine learning model, etc.). In some examples, the handwriting generation circuitry 104A-E may use hyperparameters that control model performance and training speed such as the learning rate and regularization parameter(s). The handwriting generation circuitry 104A-E may select such hyperparameters by, for example, trial and error to reach an optimal model performance. In examples disclosed herein, a first hyperparameter controls weights provided to certain components in a loss function. Specifically, the first hyperparameter controls the weight distributed to an MDN error component of the loss function as well as an MSE component of the loss function to account for character-level and/or word-level stylistic and positional differences when comparing the generated handwriting to corresponding original handwriting. In examples disclosed herein, other hyperparameters control a learning rate, a batch size, and/or a quantity of training steps. In examples disclosed herein, the handwriting generation circuitry 104A-E performs re-training. Specifically, the handwriting generation circuitry 104A-E re-trains the DHG model 124, or trains a separate version of the DHG model 124, in response to encountering a new or additional handwriting style (e.g., a new or additional author). During re-training, the handwriting generation circuitry 104A-E maintains a fixed version of a first portion of the DHG model 124 (e.g., lower-level layers, the LSTM layers, etc.) while re-training a second portion of the DHG model 124 (e.g., the MDN layer) using MAML techniques and running a few gradient descent steps with a small number of data samples (e.g., twenty or fewer handwritten words).

Training is performed using training data. In some examples, during the initial training period, the handwriting generation circuitry 104A-E utilizes training data that originates from online, publicly available handwriting samples, such as those in the IAM On-Line Handwriting Database. In some examples, during the initial training period, the handwriting generation circuitry 104A-E utilizes handwriting samples collected by the external electronic devices 130 as the training data. In examples disclosed herein, during the author-specific training period, the handwriting generation circuitry 104A-E utilizes twenty or fewer handwritten words numbers, and/or symbols provided by the user as training data.

Once training is complete, the handwriting generation circuitry 104A-E may deploy the DHG model 124 for use as an executable construct that processes an input and provides an output based on the network of nodes and connections defined in the DHG model 124. The handwriting generation circuitry 104A-E may store the DHG model 124 in the datastore 120. In some examples, the handwriting generation circuitry 104A-E may invoke the interface circuitry 114 to transmit the DHG model 124 to one(s) of the external electronic systems 130. In some such examples, the handwriting generation circuitry 104A-E enables one(s) of the external electronic systems 130 to generate digitized handwriting for a user without being directly provided training data from the user. Accordingly, the electronic system 102 enables the trained DHG model 124 for a particular user to be deployed at any device associated with the user to avoid having to reduce training for the user.

Once trained, the deployed DHG model 124 may be operated in an inference phase to process data. In the inference phase, data to be analyzed (e.g., live data) is input to the DHG model 124, and the DHG model 124 executes to create an output. This inference phase can be thought of as the AI “thinking” to generate the output based on what it learned from the training (e.g., by executing the DHG model 124 to apply the learned patterns and/or associations to the live data). In some examples, input data undergoes pre-processing before being used as an input to the DHG model 124. For example, the handwriting generation circuitry 104A-E may cause an image of a handwritten document to undergo optical character recognition to enable characters in the handwritten document to serve as the input for the DHG model 124. Moreover, in some examples, handwriting generation circuitry 104A-E causes the output data to undergo post-processing after it is generated by the DHG model 124 to transform the output into a useful result (e.g., an SVG or SVGZ file, a display of data, an instruction to be executed by a machine, etc.).

In some examples, output of the deployed DHG model 124 may be captured and provided as feedback. By analyzing the feedback, the handwriting generation circuitry 104A-E can determine an accuracy of the deployed DHG model 124. In some examples, if the feedback indicates that the accuracy of the deployed DHG model 124 is less than a threshold or other criterion, the handwriting generation circuitry 104A-E can trigger using the feedback and an updated training data set, hyperparameters, etc., to generate an updated, deployed DHG model 124.

In examples operation, the handwriting generation circuitry 104A-E trains the DHG model 124 based on the training data 122. For example, the third handwriting generation circuitry 104C of the first hardware accelerator 108 can retrieve the DHG model 124 from the datastore 120, the external electronic systems 130 via the network 128, etc. In some examples, the third handwriting generation circuitry 104C can retrieve the training data 122, or a portion thereof, from the datastore 120, the user interface circuitry 126, the network 128, the external electronic systems 130, etc.

During an initial training period, the handwriting generation circuitry 104A-E can retrieve a first portion of the training data 122 (e.g., the IAM On-Line Handwriting Database) from the datastore 120 and/or the network 128. In turn, the example handwriting generation circuitry 104A-E can train the DHG model 124 to generate handwriting sequences corresponding to original handwritten sequences in the first portion of the training data 122. Specifically, the example handwriting generation circuitry 104A-E can train the DHG model 124 to synthesize ink coordinates for the generated handwriting sequences based on the original handwritten sequences using a recurrent neural network architecture with a reparameterization layer to adapt the DHG model 124 based on an MDN loss and a mean squared error of the generated handwriting sequences with respect to the original handwritten sequences. The first portion of the training data 122 can include original handwriting sequences with various styles and/or languages such that the example handwriting generation circuitry 104A-E can train the DHG model 124 to learn a generalized handwriting style. In some examples, the handwriting generation circuitry 104A-E causes the datastore 120 to maintain a generalized version of the DHG model 124 such that the generalized version of the DHG model 124 can be copied and at least a portion of the generalized version of the DHG model 124 can be adapted to styles presented by encountered users.

In response to training the DHG model 124 to learn the generalized handwriting style, the handwriting generation circuitry 104A-E can retrieve a second portion of the training data 122 (e.g., twenty or fewer handwritten words, numbers, and/or symbols from a user) via the user interface circuitry 126. For example, a user can write the second portion of the training data 122 on a touch screen of the user interface circuitry 126, scan the second portion of the training data 122 via a scanner of the user interface circuitry 126, and/or capture an image of the second portion of the training data 122 via a camera of the user interface circuitry 126. Alternatively, the user interface circuitry 126 can capture a handwriting sample from the user in any other manner. In some examples, when the user writes the second portion of the training data 122 on the touch screen of the user interface circuitry 126, the example handwriting generation circuitry 104A-E can utilize a first twenty words, numbers, and/or symbols written by the user as the second portion of the training data 122. Thus, the user can continue to write on the touch screen of the user interface circuitry 126 uninterrupted as the handwriting generation circuitry 104A-E retrieves the second portion of the training data 122 and enables the DHG model 124 to learn a specific style displayed by the writing from the user in substantially real time.

In turn, the example handwriting generation circuitry 104A-E can cause the DHG model 124 to generate handwriting sequences corresponding to the sequences obtained via the user interface circuitry 126. Specifically, the handwriting generation circuitry 104A-E can cause the DHG model 124 to learn a user-specific style displayed by the sequences obtained via the user interface circuitry 126 based on the MDN errors and the mean squared errors of the generated handwriting sequences with respect to the original handwriting sequences and/or the user-written handwriting sequences. During this user-specific training period, a first portion of the DHG model 124 remains fixed with weights and/or connections set based on the initial training period while a second portion of the DHG model 124 adapts to the style displayed by the user using few-shot learning techniques and empirically selected hyperparameters for brief learning tasks, such as learning rate, batch size, and/or a quantity of training steps. As a result, the example handwriting generation circuitry 104A-E can cause the DHG model 124 to adopt the handwriting style of the user in substantially real time as the user continues to write (e.g., on the touch screen of the user interface circuitry 126). In some examples, in response to training the DHG model 124 to learn the user-specific handwriting style, the handwriting generation circuitry 104A-E can cause the user interface circuitry 126 to prompt the user to provide a label for the handwriting style, such as a name of the user. In turn, the handwriting generation circuitry 104A-E can store the DHG model 124 specifically generated for the handwriting style of the user in the datastore 120. Similarly, the handwriting generation circuitry 104A-E can copy and adapt the generalized version of the DHG model 124 to other encountered handwriting styles and assign unique labels to the different handwriting styles. As such, ones of the DHG model 124 associated with the handwriting styles of the respective users can be utilized for example inference operations to generate digitized handwriting corresponding to the style of the user when the user is encountered.

During an example inference operation, the user interface circuitry 126 can provide a writing sample, such as a document image, plain text, handwriting sequences recorded on a touch screen to the handwriting generation circuitry 104A-E. Further, the handwriting generation circuitry 104A-E can identify a user style to be utilized based on configuration settings selected by the user at the user interface circuitry 126. In turn, the handwriting generation circuitry 104A-E can cause execution of the respective DHG model 124 associated with the user style and provide the writing sample as an input to cause the DHG model to output the writing in a digitized format that is searchable and editable.

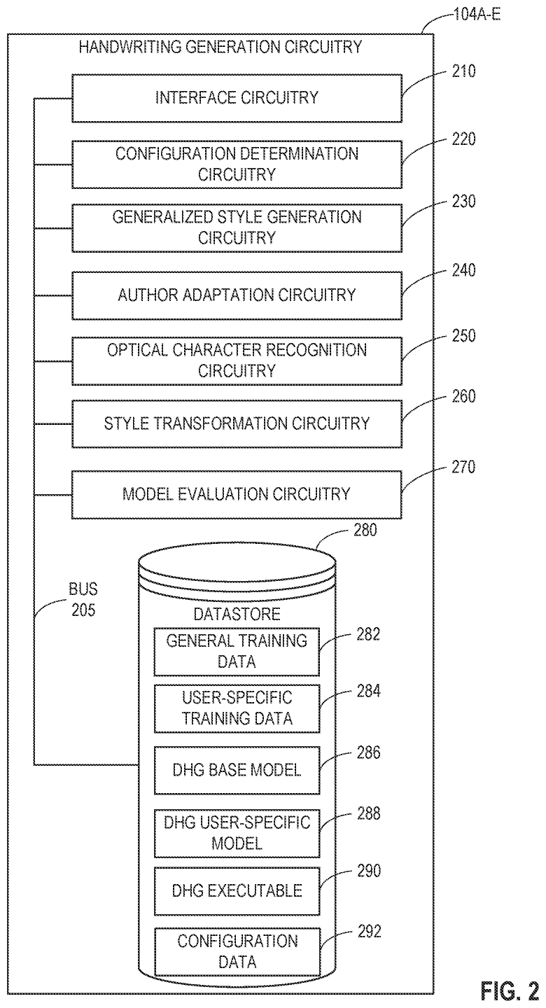

FIG. 2 is a block diagram of the example handwriting generation circuitry 104A-E to cause training, deployment, instantiation, and/or execution of the DHG model 124 to generate digitized handwriting with user-specific style. The handwriting generation circuitry 104A-E of FIG. 2 may be instantiated (e.g., creating an instance of, bring into being for any length of time, materialize, implement, etc.) by processor circuitry such as a central processing unit executing instructions. Additionally or alternatively, the handwriting generation circuitry 104A-E of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the example handwriting generation circuitry 104A-E may be instantiated, for example, in one or more threads executing concurrently on hardware and/or in series on hardware. Moreover, in some examples, some or all of the example handwriting generation circuitry 104A-E of FIG. 2 may be implemented by microprocessor circuitry executing instructions to implement one or more virtual machines and/or containers.

The handwriting generation circuitry 104A-E of FIG. 2 includes an example bus 205, example interface circuitry 210, example configuration determination circuitry 220, example generalized style generation circuitry 230, example author adaptation circuitry 240, example optical character recognition circuitry 250, example style transformation circuitry 260, example model evaluation circuitry 270, and an example datastore 280. The datastore 280 of the illustrated example includes example general training data 282 (e.g., a first portion of the training data 122 of FIG. 1), example user-specific training data 284 (e.g., a second portion of the training data 122 of FIG. 1), an example DHG base model 286, an example DHG user-specific model 288, an example DHG executable 290, and example configuration data 292. In the illustrated example of FIG. 2, the interface circuitry 210, the configuration determination circuitry 220, the generalized style generation circuitry 230, the author adaptation circuitry 240, the optical character recognition circuitry 250, the example style transformation circuitry 260, the example model evaluation circuitry 270, and the datastore 280 are in communication with the bus 205. In some examples, the bus 205 can be implemented with bus circuitry, bus software, and/or bus firmware. For example, the bus 205 can be implemented by at least one of an Inter-Integrated Circuit (I2C) bus, a Serial Peripheral Interface (SPI) bus, a Peripheral Component Interconnect (PCI) bus, or a Peripheral Component Interconnect Express (PCIe or PCIE) bus. Additionally or alternatively, the bus 205 can be implemented by any other type of computing or electrical bus.

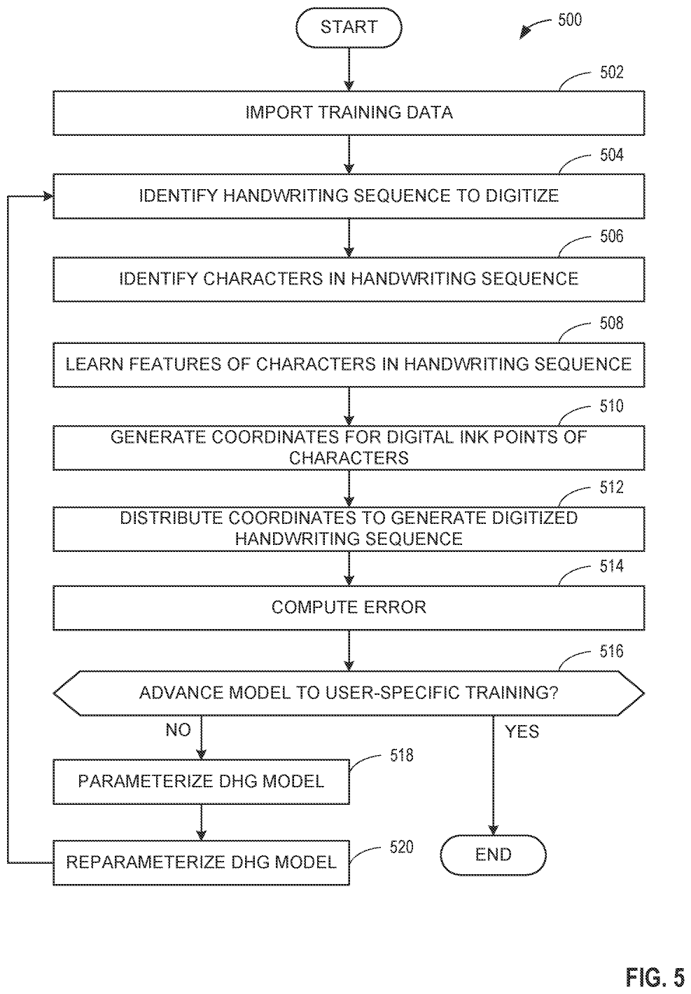

The handwriting generation circuitry 104A-E of FIG. 2 includes the interface circuitry 210 to receive and/or transmit data. In some examples, the interface circuitry 210 receives data, such as the general training data 282, via the network 128 of FIG. 1. For example, the interface circuitry 210 can download the general training data 282 from the Internet. In some examples, the interface circuitry 210 receives data, such as the user-specific training data 284 and/or a change in configuration (e.g., the configuration data 292), from the user interface circuitry 126 of FIG. 1. In some examples, the interface circuitry 210 receives data, such as the example DHG base model 286, the example DHG user-specific model 288, and/or the DHG executable 290, from one(s) of the external electronic systems 130 via the network 128. In some examples, the interface circuitry 210 receives data, such as, the general training data 282, the user-specific training data 284, the DHG base model 286, the DHG user-specific model 288, the DHG executable 290, and/or the configuration data 292, from the datastore 120 of FIG. 1 (e.g., by way of the bus 116 of FIG. 1). In some examples, the interface circuitry 210 receives content input data, such as data corresponding to a document image, plain text, handwriting sequences recorded on a touch screen, etc. to serve as an input for the DHG user-specific model 288 and/or the DHG executable 290 via the user interface circuitry 126 of FIG. 1 (e.g., by way of the bus 116 of FIG. 1). In some examples, the interface circuitry 210 is instantiated by processor circuitry executing interface instructions and/or configured to perform operations such as, for example, those instructions and/or operations represented by the flowcharts of FIGS. 5, 6, 7, and/or 8.

The handwriting generation circuitry 104A-E of FIG. 2 includes the configuration determination circuitry 220 to identify and/or determine a configuration to be utilized for operations of the handwriting generation circuitry 104A-E. For example, in response to the DHG base model 286 not being trained, the configuration determination circuitry 220 can determine initial training operations are to be performed to form the DHG base model 286. Further, in response to the DHG user-specific model 288 not being trained, the configuration determination circuitry 220 can determine user-specific training operations are to be performed to form the DHG user-specific model 288. Similarly, in response to the user interface circuitry 126 receiving an indication of a new or additional user being encountered, the configuration determination circuitry 220 can determine additional user-specific training operations are to be performed to form another version of the DHG user-specific model 288 for the new or additional user. In some examples, the configuration determination circuitry 220 sets a respective version of the DHG user-specific model 288 to utilize based on a selection by a user at the user interface circuitry 126 indicating a corresponding identifier associated with the handwriting style of the DHG user-specific model 288. In such examples, the configuration determination circuitry 220 can convert the respective DHG user-specific model to an executable file (e.g., the DHG executable 290) to be executed to generate digitized handwriting content corresponding to an input. In some examples, the configuration determination circuitry 220 is instantiated by processor circuitry executing configuration determination instructions and/or configured to perform operations such as, for example, those instructions and/or operations represented by the flowcharts of FIGS. 5, 6, 7, and/or 8.

The handwriting generation circuitry 104A-E of FIG. 2 includes the generalized style generation circuitry 230 to generate the DHG base model 286. In some examples, in response to the configuration determination circuitry 220 determining initial training operations are to be performed (e.g., determining the DHG base model 286 has not yet been trained), the generalized style generation circuitry 230 trains the DHG base model 286 using the general training data 282. Specifically, the generalized style generation circuitry 230 can execute the DHG base model 286 during an initial training phase using the general training data 282 as an input. The general training data 282 can include handwriting sequences including a series of strokes represented by vectors that are temporally and/or spatially organized. Additionally, the general training data 282 can include one-hot bits indicative of respective characters and/or character sequences in the handwriting sequences (e.g., American Standard Code for Information Interchange (ASCII) codes). A one-hot bit is a group of bits among which only a single bit is high (e.g., has a value of 1) and all other bits are low (e.g., have a value of 0). Accordingly, the respective bit that is high can correspond to a character (e.g., a letter), a character sequence (e.g., a word), and/or character sequences (e.g., a sentence(s), a paragraph(s), etc.). By executing the DHG base model 286 with the general training data 282, the generalized style generation circuitry 230 causes the DHG base model 286 to perform a parameterization and a reparameterization of weights and connections between nodes based on similarity results computed using a loss function represented below by Equation (1).

(1−λ))MDNloss+λMSE(Sₒ,Sₚ),0<λ<1, Equation (1)

In Equation (1), Sₒ is representative of an original handwriting sequence vector, Sₚ is representative of a predicted handwriting sequence vector, MDNloss (e.g., mixture density network loss) is representative of a style loss, MSE is representative of a mean squared error that indicates a pixel-wise loss in coordinates of digital ink in the predicted handwriting sequence compared to coordinates of ink in the original handwriting sequence, and λ is a hyperparameter that applies weights to the MDNloss and the MSE for the error computation. In this example, configuration determination circuitry 220 and/or the generalized style generation circuitry 230 set the λ value as 0.2, which may be stored in the configuration data 292. In some examples, the value of 0.2 for λ results in the best (i.e., lowest) validation error scores. In this example, the coordinates are x-y coordinates on a page with a third temporal value and a binary value indicative whether the specific x-y coordinate contains ink. That is, the binary ink value can be 1 in locations where a pen did not contact a screen or substrate and 0 otherwise. Moreover, the x-y coordinates are integer values constrained by a resolution of (e.g., captured by) the user interface circuitry 126.

In the illustrated example, the MDNloss provides a first weighted error based on a difference between the distribution of the generated digital ink points for characters and/or words in the predicted handwriting sequence and an actual distribution of ink for characters and/or words in the original handwriting sequence. As such, the MDNloss helps train the DHG base model 286 to replicate styles of characters and/or words encountered in the general training data 282. Moreover, the MSE provides a second weighted error based on a difference between coordinates of the generated digital ink points and coordinates occupied by ink in the original handwriting sequence. As such, the MSE helps train the DHG base model 286 to replicate a relative position of ink points on a page and, in turn, helps prevent step-by-step deviations between coordinates of generated ink points and original ink (e.g., an uptrend, a downtrend, a left-trend, a right-trend) that would otherwise be left undetected with MDNloss alone. In some examples, during the initial training, generalized style generation circuitry 230 causes the DHG base model 286 to perform the parameterization and the reparameterization until the loss indicated by Equation (1) is no longer reducing or otherwise trends toward stability with training iterations. In some examples, during the initial training, generalized style generation circuitry 230 causes the DHG base model 286 to perform the parameterization and the reparameterization until the loss indicated by Equation (1) satisfies (e.g., is less than) a loss threshold. In some examples, during the initial training, generalized style generation circuitry 230 causes the DHG base model 286 to perform the parameterization and the reparameterization until all of the general training data 282 has been utilized as an input in the DHG base model 286.

The DHG base model 286 is a recurrent sequence model. Thus, the DHG base model 286 generates a sequence of coordinates in an autoregressive manner (i.e., predicts one coordinate step at a time and feeds the coordinate back to the DHG base model 286 as an input to predict the next sequence element). Additionally, the DHG base model 286 models the first order difference, which causes the starting coordinate difference for autoregressive generation to be temporally offset by one data point.

To enable the DHG base model 286 to be adaptable to styles displayed by various users, the generalized style generation circuitry 230 causes the DHG base model 286 to initialize hidden states during the initial training period. In some examples, the generalized style generation circuitry 230 is instantiated by processor circuitry executing generalized style generation instructions and/or configured to perform operations such as, for example, those instructions and/or operations represented by the flowchart of FIG. 5.

The handwriting generation circuitry 104A-E of FIG. 2 includes the author adaptation circuitry 240 to copy and adapt the DHG base model 286 based on a handwriting sample from a user (e.g., the user-specific training data 284) to form the DHG user-specific model 288 during a user-specific training period. For example, the author adaptation circuitry 240 can determine the user-specific training is to occur in response to the configuration determination circuitry 220 identifying that handwriting from a new or additional user is encountered. For example, the new or additional user can select or otherwise indicate that a new or additional handwriting style is to be generated via the user interface circuitry 126.

In some examples, the author adaptation circuitry 240 causes the DHG user-specific model 288 to learn and/or adapt to new or additional user styles using optimization-based MAML, which is a few-shot learning technique that learns through a few gradient descent steps. Because the user-specific training data 284 includes a relatively small samples size (e.g., twenty or fewer handwritten words, numbers, and/or symbols), the author adaptation circuitry 240 can cause the DHG user-specific model 288 to efficiently update parameters (e.g., weighting values and/or connections) of the DHG base model 286 by running the DHG user-specific model 288 with the user-specific training data 284 as an input and adjusting parameters between run iterations using the gradient descent steps. In particular, the author adaptation circuitry 240 causes a first portion of the DHG user-specific model 288 to match (e.g., be maintained with, remain identical to, etc.) a configuration set in the DHG base model 286. Further, the author adaptation circuitry 240 causes a second portion of the DHG user-specific model 288 to be different from the DHG base model 286 and correspond with style characteristics displayed by the sample data from the user. Specifically, adaptations to the second portion of the DHG user-specific model 288 can correspond to a vector (e.g., a style encoding vector) that is computed by taking a given real coordinate sequence from the user and running the vector through the DHG user-specific model 288 with few gradient descent steps to compute weights and/or connections to be utilized in the second portion of the DHG user-specific model 288 (e.g., the final hidden states of the DHG user-specific model 288). As such, the style encoding vector for the specific user can be computed once to update the DHG user-specific model 288 and then utilized to digitize any subsequent writing from the user.

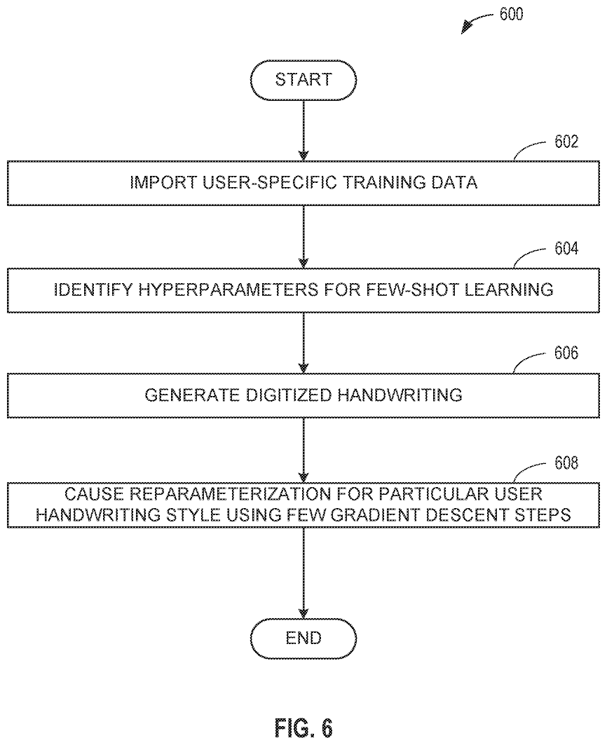

In some examples, the author adaptation circuitry 240 assigns a label to the DHG user-specific model 288 and/or the specific style encoding vector generated for the user based on an indication from the user (e.g., a response to a prompt at the user interface circuitry 126 requesting a name for the handwriting style). In response to training the DHG user-specific model 288, the author adaptation circuitry 240 can create an executable file (e.g., the DHG executable 290) corresponding to the DHG user-specific model 288 for subsequent digitized handwriting generation for the given user. Accordingly, the author adaptation circuitry 240 can create ones of the DHG user-specific model 288 and/or the DHG executable 290 for respective handwriting styles encountered (e.g., users encountered). In some examples, the author adaptation circuitry 240 is instantiated by processor circuitry executing author adaptation instructions and/or configured to perform operations such as, for example, those instructions and/or operations represented by the flowchart of FIG. 6.

The handwriting generation circuitry 104A-E of FIG. 2 includes the optical character recognition circuitry 250 to perform optical character recognition on handwriting samples provided by users. In some examples, the optical character recognition circuitry 250 performs optical character recognition on the handwriting from a user in the user-specific training data 284 and/or encountered by the interface circuitry 210 (e.g., in a non-text format) for digitized handwriting generation. In some examples, the optical character recognition circuitry 250 is instantiated by processor circuitry executing optical character recognition instructions and/or configured to perform operations such as, for example, those instructions and/or operations represented by the flowcharts of FIGS. 6 and/or 7.

The handwriting generation circuitry 104A-E of FIG. 2 includes the style transformation circuitry 260 to execute and/or otherwise cause or invoke execution of the DHG user-specific model 288 to generate digitized handwriting corresponding to an input provided by the user (e.g., at the user interface circuitry 126). In some examples, the style transformation circuitry 260 determines the respective DHG user-specific model 288 and/or the respective DHG executable 290 to be utilized based on an indication (e.g., a selection) by the user at the user interface circuitry 126. For example, the user can select or input the label corresponding to the DHG user-specific model 288 and/or the respective DHG executable 290 at the user interface circuitry 126, which can relay the selection or input to the interface circuitry 210 of the handwriting generation circuitry 104A-E along with writing from the user to be digitized. In some examples, the interface circuitry 210 updates the configuration data 292 based on the respective DHG user-specific model 288 and/or the respective DHG executable 290 to be utilized.

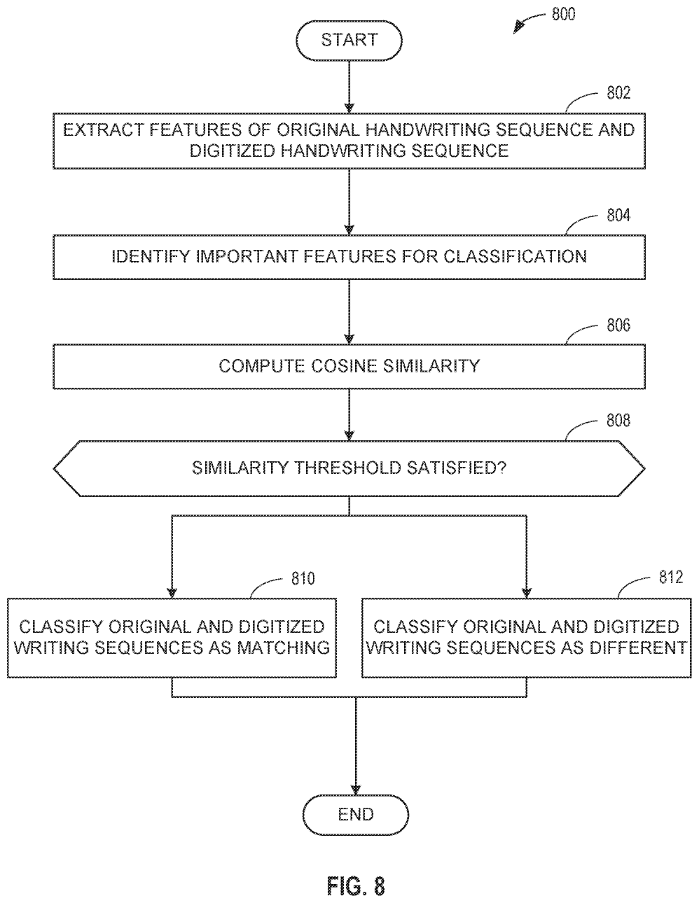

In the illustrated example, the electronic system 102 can receive the writing from the user as an image of a written document, a text document with text to be converted to digitized handwriting, and/or a direct writing input (e.g., with a cursor on a computer or laptop, with contact on a touchscreen of a tablet, mobile device, or interactive whiteboard, etc.). In some examples, the style transformation circuitry 260 causes the optical character recognition circuitry 250 to identify characters in the writing in response to the writing received as an image or a direct writing input. In turn, the style transformation circuitry 260 can cause execution of the DHG user-specific model 288 and/or the respective DHG executable 290 to convert the writing into digitized content. In some examples, the style transformation circuitry 260 outputs the digitized content as a scalable vector in an SVG format or a compressed SVGZ format that reduces (i.e., minimizes) storage space occupied by the digitized content. In some examples, the style transformation circuitry 260 is instantiated by processor circuitry executing style transformation instructions and/or configured to perform operations such as, for example, those instructions and/or operations represented by the flowchart of FIG. 8.

The handwriting generation circuitry 104A-E of FIG. 2 includes the model evaluation circuitry 270 to perform an objective evaluation of the digitized content. In some examples, in response to the input from the user received as an image or a direct writing input, the model evaluation circuitry 270 determines a similarity between the digitized content and the input. For example, the model evaluation circuitry 270 can utilize a Freshet Inception Distance (FID) based approach to perform the objective evaluation at a sentence-level. In some examples, in the FID-based approach, the model evaluation circuitry 270 takes a key image and a query image as inputs and determines whether the key and query images belong to the same user (e.g., intra-class) or to a different user (e.g., inter-class).

In intra-class evaluations, the model evaluation circuitry 270 utilizes the original handwriting from the user as the key image and utilizes the digitized content that the DHG user-specific model 288 and/or the DHG executable 290 produced for the original handwriting as the query image. In some example intra-class evaluations, the model evaluation circuitry 270 utilizes the original handwriting from the user as the key image and utilizes digitized content that the DHG user-specific model 288 and/or the DHG executable 290 produced for a different handwriting sequence from the user as the query image to enable style to be compared across different text. In inter-class evaluations, the model evaluation circuitry 270 utilizes digitized content generated for a first user by a first one(s) of the DHG user-specific model 288 and/or the DHG executable 290 as the key image and utilizes digitized content generated for a second user by a second one(s) of the DHG user-specific model 288 and/or the DHG executable 290 as the query image to evaluate distinctions between generated handwriting styles.

In some examples, the model evaluation circuitry 270 includes and/or utilizes a feature extractor (e.g., a Visual Geometry Group (VGG) model, VGG16, etc.) and a convolutional neural network (CNN) to extract and identify features in the key and query images that have an impact on the classification. In turn, the model evaluation circuitry 270 can compute a cosine similarity of the identified features in the key and query images. In response to the cosine similarity satisfying (e.g., being greater than) a cosine similarity threshold, the model evaluation circuitry 270 classifies the key and query images as being from the same user. Conversely, in response to the cosine similarity not satisfying (e.g., being less than) the cosine similarity threshold, the model evaluation circuitry 270 classifies the key and query images as being from different users. Therefore, the model evaluation circuitry 270 can evaluate an accuracy as well as an adaptability of ones of the DHG user-specific model 288.

In some examples, after the model evaluation circuitry 270 performs the inter-class evaluation with at least a certain quantity of samples, the model evaluation circuitry 270 can cause the author adaptation circuitry 240 to modify or replace (e.g., retrain) the DHG user-specific model 288 in response to a percentage of the key and query images in the inter-class evaluation not satisfying the cosine similarity threshold being greater than a threshold percentage. In such examples, the model evaluation circuitry 270 can consider a quantity of samples recently encountered (e.g., a most recent 20 samples encountered from the user, a most recent 50 samples encountered from the user, etc.) to enable the author adaptation circuitry 240 to adapt the DHG user-specific model 288 when the handwriting style of the user changes (e.g., as the user matures). In such examples, the interface circuitry 210 can replace a previous version of the user-specific training data 284 with handwriting sequences more recently encountered from the user for a second user-specific training period. In some examples, the model evaluation circuitry 270 is instantiated by processor circuitry executing model evaluation instructions and/or configured to perform operations such as, for example, those instructions and/or operations represented by the flowchart of FIG. 8.

The handwriting generation circuitry 104A-E of FIG. 2 includes the datastore 280 to record data, such as the general training data 282, the user-specific training data 284, the DHG base model 286, the DHG user-specific model 288, the DHG executable 290, the configuration data 292, etc. In some examples, the datastore 280 records the digitized content outputted by one(s) of the DHG user specific model 288. The datastore 280 can be implemented by a volatile memory (e.g., a Synchronous Dynamic Random Access Memory (SDRAM), Dynamic Random Access Memory (DRAM), RAMBUS Dynamic Random Access Memory (RDRAM), etc.) and/or a non-volatile memory (e.g., flash memory). The datastore 280 may additionally or alternatively be implemented by one or more double data rate (DDR) memories, such as DDR, DDR2, DDR3, DDR4, DDR5, mobile DDR (mDDR), DDR SDRAM, etc. The datastore 280 may additionally or alternatively be implemented by one or more mass storage devices such as hard disk drive(s) (HDD(s)), compact disk (CD) drive(s), digital versatile disk (DVD) drive(s), solid-state disk (SSD) drive(s), Secure Digital (SD) card(s), CompactFlash (CF) card(s), etc. While in the illustrated example the datastore 280 is illustrated as a single datastore, the datastore 280 may be implemented by any number and/or type(s) of datastores. Furthermore, the data stored in the datastore 280 may be in any data format such as, for example, image data, text data, binary data, comma delimited data, tab delimited data, structured query language (SQL) structures, SVG or SVGZ files, etc.

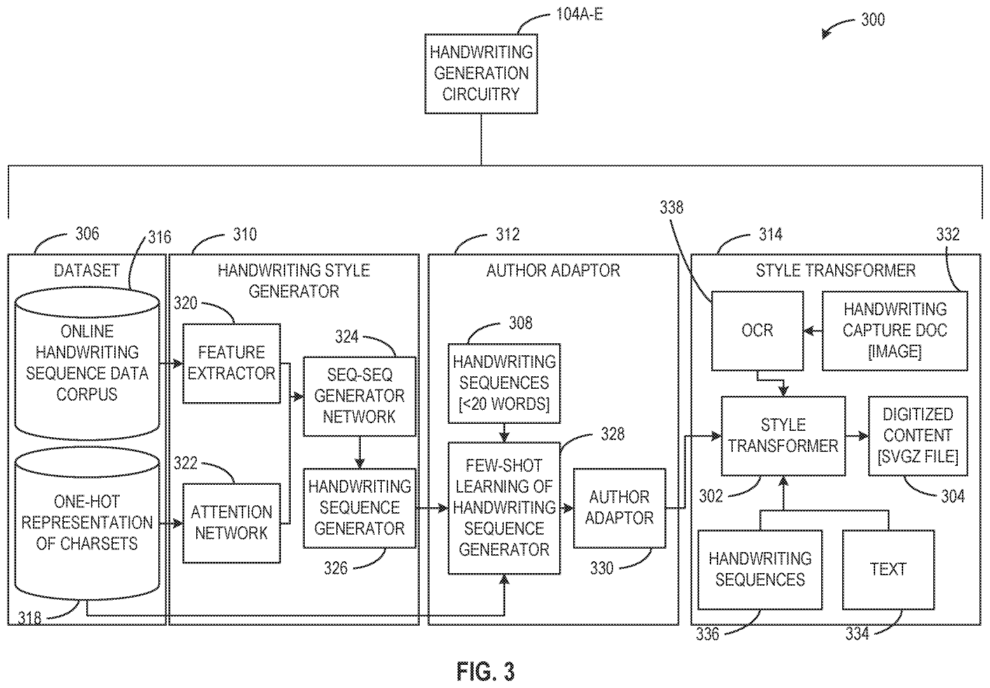

FIG. 3 is a schematic overview 300 of example training and execution of a DHG neural network model (e.g., the DHG model 124 of FIG. 1, the DHG base model 286 of FIG. 2, the DHG user-specific model 288 of FIG. 2) by the handwriting generation circuitry 104A-E. For example, the handwriting generation circuitry 104A-E can train an example style transformer model 302 to generate a digitized handwriting output 304 (identified by DIGITIZED CONTENT [SVGZ FILE]) based on an example training dataset 306 and user-specific handwriting sequences 308. The schematic overview 300 of the illustrated example includes the training dataset 306 (identified by DATASET), a first example stage 310 (identified by HANDWRITING STYLE GENERATOR), a second example stage 312 (identified by AUTHOR ADAPTOR), and a third example stage 314 (identified by STYLE TRANSFORMER).

The training dataset 306 of the illustrated example includes an example online handwriting sequence data corpus 316 and an example one-hot representation of character sets database 318. In some examples, data in the one-hot representation of character sets database 318 is indicative of characters in handwriting sequences in the online handwriting sequence data corpus 316.

The first stage 310 of the illustrated example includes an example feature extractor 320, an example attention network 322, an example sequence-to-sequence generator network 324, and an example handwriting sequence generator 326. In the illustrated example, the feature extractor 320 processes the handwriting sequences in the online handwriting sequence data corpus 316 to learn features of characters in the handwriting sequences. For example, the feature extractor 320 can be a deep learning model that automatically learns features of encountered characters.

In the illustrated example, the attention network 322 identifies the characters corresponding to the features identified by the feature extractor 320 using the one-hot representation of character sets database 318. In turn, the sequence-to-sequence generator network 324 can correlate the characters with the identified features and indicate such correlations between the characters and the identified features to the handwriting sequence generator 326. In some examples, the sequence-to-sequence generator network 324 parameterizes predictions of distributions of coordinates for characters in the DHG model using a MDN. For example, the sequence-to-sequence generator network 324 can parameterize weights and/or connections between nodes in the DHG model based on the identified features for respective characters. Furthermore, the handwriting sequence generator 326 can reparametrize the weights and/or connections between nodes in the DHG model based on an error computed by a reparameterization layer using Equation (1). In response to the error no longer decreasing with training iterations (e.g., in response to the error being minimized), the handwriting sequence generator 326 can output a base model (e.g., the DHG base model 286) capable of generating digitized handwriting in a generic style learned through the various handwriting sequences in the online handwriting sequence data corpus 316.

The second stage 312 of the illustrated example includes the example user-specific handwriting sequences 308, an example few-shot learning model 328 (identified by FEW-SHOT LEARNING OF HANDWRITING SEQUENCE GENERATOR), and an example author adaptor network 330. The example user-specific handwriting sequences 308 include handwritten words, symbols, and/or numbers from the user, such as writing obtained from the user at the user interface circuitry 126 of FIG. 1 in an image format, directly sensed on a touch screen of a tablet, laptop, and/or interactive whiteboard, formed using with a cursor on a display screen of a computer or laptop, etc. The example few-shot learning model 328 can learn a style of the user by using the user-specific handwriting sequences 308 as an input with the base model formed by the handwriting sequence generator 326. In some examples, the few-shot learning model 328 identifies the characters represented in the user-specific handwriting sequences 308 based on data in the one-hot representation of character sets database 318. In some examples, the few-shot learning model 328 utilizes optical character recognition and/or prompts the user to provide text corresponding to the handwriting sequences to determine the specific characters represented in the user-specific handwriting sequences 308.

During the user-specific training operation, the example few-shot learning model 328 adjusts weights and/or connections of a first portion of the base model (e.g., the MDN) using the reparameterization layer while maintaining the weights and/or connections in a second portion of the base model (e.g., LSTMs), which is defined at a lower level in the model than the first portion. Specifically, the example few-shot learning model 328 utilizes optimization-based MAML techniques to modify the weights and/or connections in the first portion of the base model using a few gradient descent steps. Furthermore, the example author adaptor network 330 can form a user-specific model based on the modifications to the weights and/or connections from the few gradient descent steps that result in the lowest error using Equation (1).

The third stage 314 of the illustrated example includes the example style transformer network 302 to input writing into the user-specific model to generate the example digitized handwriting output 304 (e.g., an SVGZ file). In the illustrated example, the third stage 314 includes writing inputs, such as an image 332 (identified by HANDWRITING CAPTURE DOC), text 334, and/or handwriting sequences 336 directly encountered by the user interface circuitry 126. In some examples, an example optical character recognition network 338 (e.g., the optical character recognition circuitry 250 of FIG. 2) determines characters in the image 332 and/or the handwriting sequences 336. In turn, the example style transformer network 302 can receive the text 334 and/or an indication of the characters in the writing from the optical character recognition network 338 and receive an indication corresponding to the user-specific style to be generated as inputs. Thus, the example style transformer network 302 can execute the user-specific model using the inputs to generate the digitized handwriting output 304 corresponding to the image 332, the text 334, and/or the handwriting sequences 336 provided by the user. As such, the example style transformer network 302 can convert the image 332, the text 334, and/or the handwriting sequences 336 to the digitized handwriting output 304, which is scalable, searchable, and editable.

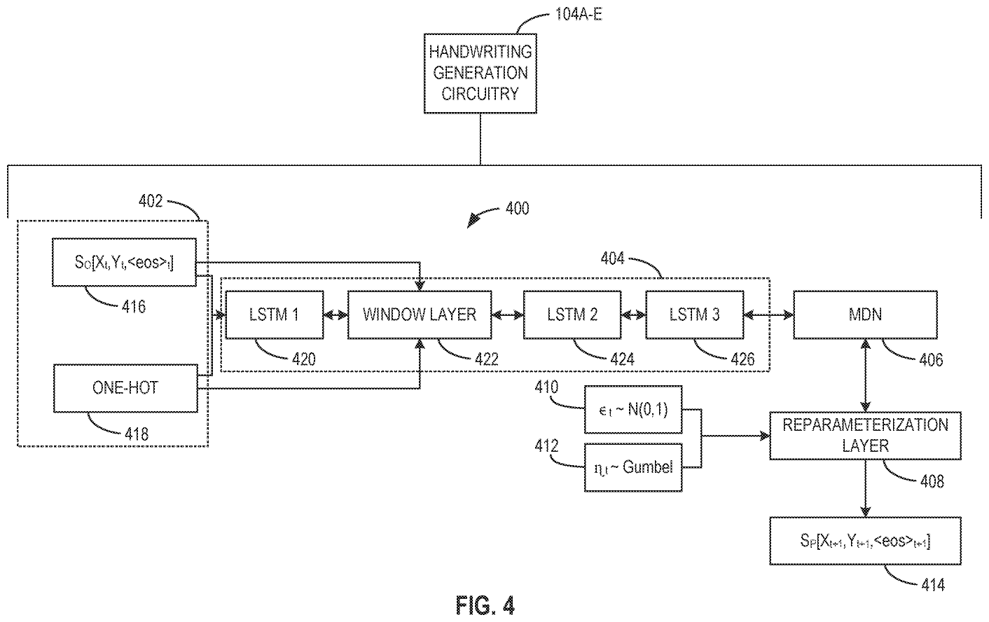

FIG. 4 is an illustration of an example machine learning model architecture 400 that can implement a DHG neural network model (e.g., the DHG model 124 of FIG. 1, the DHG base model 286 of FIG. 2, the DHG user-specific model 288 of FIG. 2, the style transformer network 302 of FIG. 3). For example, the handwriting generation circuitry 104A-E can train and/or execute the machine learning model architecture 400 to generate digitized writing corresponding to an input from a user. The machine learning model architecture 400 of the illustrated example is a neural network, such as a recurrent neural network and/or a deep neural network. The machine learning model architecture 400 of the illustrated example includes an example attention layer 402, an example sequence generation layer 404, an example MDN layer 406, an example reparameterization layer 408, example Gumbel distributed variables 410, an example Gumbel Softmax random variable 412, and example sequence prediction vectors 414 (e.g., the output). The attention layer 402 of the illustrated example includes example input sequence vectors 416 and an example one-hot vectors 418 (e.g., the input). The sequence generation layer 404 of the illustrated example includes a first example LSTM 420, an example window layer 422, a second example LSTM 424, and a third example LSTM 426.

The attention layer 402 of the illustrated example determines text (i.e., characters) to be generated as well as a digitized handwriting style in which the text is to be generated. In some examples, the input sequence vectors 416 provide data corresponding to an original handwriting sequence from a user to the sequence generation layer 404. In some examples, the one-hot vectors 418 are indicative of the characters (e.g., ASCII characters) associated with the original handwriting sequence.

During example initial training operations, the original handwriting sequence and the associated characters to be converted to digitized handwriting are downloaded or accessed via an online database (e.g., IAM On-Line Handwriting Database) and communicated to the attention layer 402 as inputs. During example user-specific training operations, the original handwriting sequence and the associated characters to be converted to digitized handwriting are obtained from the user (e.g., via the user interface circuitry 126 of FIG. 1). Similarly, during example inference operations, the original handwriting sequence and the associated characters to be converted to digitized handwriting are obtained from the user (e.g., via the user interface circuitry 126 of FIG. 1)

The sequence generation layer 404 of the illustrated example generates handwriting coordinate sequences with attention. In some examples, the first LSTM 420, the second LSTM 424, and the third LSTM 426 generate digital ink points (e.g., the handwriting coordinates) based on the original handwriting sequence and the associated characters to be converted to digitized handwriting. In some examples, the first LSTM 420, the second LSTM 424, and the third LSTM 426 generate a mixture of 2-dimensional (2-D) Gaussians to generate the digital ink points. In some examples, the window layer 422 is a sliding window that directs the attention of the first LSTM 420, the second LSTM 424, and the third LSTM 426, respectively, to different portions of the original handwriting sequence and the associated characters. In turn, the window layer 422 enables the first LSTM 420, the second LSTM 424, and the third LSTM 426 to direct respective attention to different parts of the input (e.g., the original handwriting sequence) when generating corresponding parts of an output (e.g., the digital ink points). By utilizing attention during example training operations, the first LSTM 420, the second LSTM 424, and the third LSTM 426 are able to learn the output corresponding to the input at a faster rate and with improved accuracy. Moreover, by utilizing attention during example inference operations, the first LSTM 420, the second LSTM 424, and the third LSTM 426 are able to predict digital ink points corresponding to the original handwriting sequence at a faster rate to increase a rate at which the DHG neural network generates digitized handwriting.

The MDN layer 406 of the illustrated example determines or learns a distribution of the digital ink points (e.g., the handwriting coordinates) generated by the sequence generation layer 404 for the original handwriting sequence and the associated text. During example training operations, the MDN layer 406 can parameterize the sequence generation layer 404 based on an error of the sequence prediction vectors 414 with respect to the input sequence vectors 416. In particular, the MDN layer 406 outputs parameters of a mixture model (πₜ, μⱼ^{t}, σⱼₓ^{t}, σ_{jy}^{t}, ρⱼ^{t}) from which the next digital ink point is generated by the sequence generation layer 404. For example, the MDN layer 406 can determine a probability of the next digital ink point using Equation (2).

$$\begin{matrix}P ( {x}_{t + 1} , {y}_{t + 1} \vert {c}_{t} ) = {\sum }_{j = 1}^{M} {π}_{j}^{t} 𝒩 ( {x}_{t + 1} , {y}_{t + 1} \vert {μ}_{j}^{t} , {σ}_{jx}^{t} , {σ}_{jy}^{t} , {ρ}_{j}^{t} ) \\ \{ \begin{matrix}{e}_{t} , {z}_{t + 1} = 1 \\ ( 1 - {e}_{t} ) , {z}_{t + 1} = 0\end{matrix} ,\end{matrix} \qquad Equation ( 2 )$$

In Equation (2), πₜ denotes the mixture weights, which is a vector of M weights that sums to 1, μⱼ^{t} denotes the location or mean of the jth bivariate Gaussian mixture component, σ and ρ represent the variance and covariance of the jth bivariate mixture component, respectively, and eₜ is a Boolean variable denoting pen up or down. Because the parameters of the mixture model are given by the MDN layer 406, an output (e.g., the sequence prediction vectors 414) cannot be directly generated with a forward pass through the machine learning model architecture 400. Instead, the MDN layer 406 backpropagates a distribution of the parameters of the mixture model (e.g., as 2-D Gaussians) at every time step to the sequence generation layer 404. In turn, the sequence generation layer 404 can generate a coordinate point for the digital ink based on the distribution of the parameters of the mixture model and sampling of the mixture components. In turn, the sequence generation layer 404 can feed the generated coordinate point to the MDN layer 406, which utilizes the generated coordinate point to guide the generation of 2-D Gaussians that can be fed back to the sequence generation layer 404 as the process repeats for a subsequent coordinate point.

While backpropagation is defined for deterministic functions and not stochastic functions, the reparameterization layer 408 of the illustrated example enables the backpropagation to occur in the example machine learning model architecture 400 of the illustrated example. The reparameterization layer 408 of the illustrated example outputs the sequence prediction vectors 414 based on the coordinates of the digital ink points generated by the sequence generation layer 404 and the distribution of the coordinates generated by the MDN layer 406. During example training operations, the example reparameterization layer 408 utilizes Equation (1) to compute a loss between the sequence prediction vectors 414 and the input sequence vectors 416. In turn, the reparameterization layer 408 can utilize the computed loss to determine a reparameterization of the MDN layer 406.

Specifically, the reparameterization layer 408 converts the representation of a random variable, X, following a complicated distribution, into a deterministic part and a stochastic part. The stochastic part contains a random variable from known simple distributions. For example, if X˜N(μ, σ²) is a univariate random variable following a Gaussian distribution with location parameter μ and scale parameter σ, then, using the reparameterization process or trick, the univariate random variable can be computed using Equation (3).

X=μ+σ·Z, Equation (3)

In Equation (3), Z˜N(0, 1). Furthermore, the deterministic part is μ and the stochastic part is a Z, which can be represented in terms of a known simple distribution (i.e., a standard Gaussian distribution). The reparameterization layer 408 extends this to multi-variate Gaussians by changing Equation (3) to vector form, as shown in Equation (4).

X=μ+Σ_{sqrt}z,z˜N(0,I), Equation (4)

In Equation (4), z represents samples from standard bivariate Gaussian mixtures with mean (0, 0) and a 2×2 identity covariance matrix, and Σ is the multivariate extension of σ². The reparameterization layer 408 can determine Σ using Equation (5) and, in turn, Σ_{sqrt} using Equation (6), Equation (7), and Equation (8).

$$\sum = ( \begin{matrix}{σ}_{x}^{2} & ρ {σ}_{x} {σ}_{y} \\ {ρσ}_{x} {σ}_{y} & {σ}_{y}^{2}\end{matrix} ) , \qquad Equation ( 5 )$$

$${\sum }_{squrt} = \frac{1}{t} ( \begin{matrix}{σ}_{x}^{2} + s & {ρσ}_{x} {σ}_{y} \\ {ρσ}_{x} {σ}_{y} & {σ}_{y}^{2} + s\end{matrix} ) , \qquad Equation ( 6 )$$

$$s = det ( \begin{matrix}\sum \end{matrix} ) = \sqrt{( 1 - {ρ}^{2} ) {σ}_{x}^{2} {σ}_{y}^{2}} , \qquad Equation ( 7 )$$

$$t = \sqrt{trace ( \begin{matrix}\sum \end{matrix} ) + 2 s} = \sqrt{{σ}_{x}^{2} + {σ}_{y}^{2} + 2 s} , \qquad Equation ( 8 )$$

Because the reparameterization trick does not readily extend to mixture density models as a result of difficulties associated with reparameterization of the discrete distribution over mixture weights, the reparameterization layer 408 performs a 2-step reparameterization. Specifically, the reparameterization layer 408 performs a first reparameterization for the mixture components and a second reparameterization for the categorically distributed mixture weights. In particular, the reparameterization layer 408 performs the first reparameterization of the mixture components using the Gumbel distributed variables 410. Additionally, the reparameterization layer 408 performs the second reparameterization of the categorically distributed mixture weights using a Gumbel-max trick with the Gumbel Softmax random variables 412, which can be defined using Equation (9), for example.

$${( {x}_{k} )}_{1 \leq k \leq K} = softmax ( {( {ϵ}_{k} + log {π}_{k} )}_{k} ) = \frac{exp ( ( {ϵ}_{k} + log {π}_{k} ) / τ )}{{\sum }_{j} exp ( ( {ϵ}_{j} + log {π}_{j} ) / τ )} , \qquad Equation ( 9 )$$

In Equation (9), τ>0 is a temperature parameter. When τ→0, the vector xₖ becomes close to one-hot, following categorical distribution. On the other hand, when τ→+∞ the vector xₖ becomes uniformly distributed, and all samples look the same. During example training operations, the reparameterization layer 408 sets the temperature parameter, τ, to 0.01.

The Gumbel max-trick enables the reparameterization layer 408 to express a discrete categorical variable as a deterministic function of the class probabilities and independent random variables (i.e., the Gumbel distributed variables 410). For example, K with possible values having respective probabilities of πₖ can be represented as discrete categorically distributed variables, X˜P(πₖ). While a sample from the distribution of the discrete categorically distributed variables can be represented as

$$x = arg {max}_{k} ( {ϵ}_{k} + log {π}_{k} )$$

where ∈ₖ is one of Gumbel distributed variables 410, the argmax function is non-differentiable and cannot be used in a backpropagation setting. Instead, the reparameterization layer 408 replaces the argmax with the softmax function in Equation (9) to make the function differentiable and, thus, enables backpropagation.

As a result, the reparameterization layer 408 can first compute one-hot samples mᵢ for mixture weights using Gumbel softmax reparameterization and subsequently compute the samples for each component of the bivariate Gaussian mixtures using reparameterization. Specifically, by setting the temperature parameter, τ, sufficiently small (e.g., at 0.01) in Equation (9), most of the mᵢ are close to 0 and only one mᵢ is close to 1. In turn, the reparameterization layer 408 enables the coordinates for the digital ink points to be directly computed using Equation (10).

(xₜ₊₁,yₜ₊₁)^{T}=+Σᵢmᵢ(μᵢ+Sᵢzₜ), Sᵢ=sqrtΣᵢ, Equation (10)

In some examples, in advance of training the DHG model, the model evaluation circuitry 270 of FIG. 2 performs a comparison between the samples generated by reparameterization layer 408 and samples drawn from a mixture model to empirically validate the generated samples. In response to the samples being empirically validated, the reparameterization layer 408 can cause the generated samples to pass through the machine learning model architecture 400 with an input batch during training of the DHG model.

As such, the example sequence generation layer 404 and the example MDN layer 406 can directly compute the sequence prediction vectors 414. During example training operations, the reparameterization layer 408 compares the computed sequence prediction vectors 414 with the input sequence vectors 416. Because the MDN layer 406 determines the distribution of the coordinates of the digital ink points and, thus, models a difference series between successive coordinates generated by the sequence generation layer 404, the reparameterization layer 408 compares a cumulative sum of the computed sequence prediction vectors 414 with a cumulative sum of the input sequence vectors 416 to determine the MSE and the MDN loss of Equation (1). Accordingly, the example reparameterization layer 408 can compute the overall error between the computed sequence prediction vectors 414 and the input sequence vectors 416. Further, the example reparameterization layer 408 utilizes gradient descent to modify weights and/or connections in the sequence generation layer 404 and/or the MDN layer 406 to reduce (i.e., minimize) the overall error between the computed sequence prediction vectors 414 and the input sequence vectors 416. In response to determining weights and/or connections in the sequence generation layer 404 and the MDN layer 406 that result in a small (i.e., minimal) error with a generalized training dataset (e.g., the general training data 282 of FIG. 2), the generalized style generation circuitry 230 of FIG. 2 can cause the weights and/or connections in the sequence generation layer 404 to remain fixed.

Further, to adapt the machine learning model architecture 400 to a specific handwriting style of a user, the author adaptation circuitry 240 of FIG. 2 can cause user-specific samples (e.g., from the user-specific training data 284) to serve as the input sequence vectors 416. As such, the sequence generation layer 404 generates coordinates for digital ink points and the MDN layer generates a distribution of the coordinates to produce the sequence prediction vectors 414 associated with the input sequence vectors 416 for the user-specific samples. Moreover, the example reparameterization layer 408 can determine a loss or error between a cumulative sum of the sequence prediction vectors 414 and the input sequence vectors 416 using Equation (1). As a result, the example reparameterization layer 408 determines modifications to weights and/or connections in the MDN layer 406 to reduce (i.e., minimize) the error using few gradient descent steps, which enable the machine learning model architecture 400 to adapt to the handwriting style of the user with few data samples (e.g., less than twenty handwritten words and/or symbols). In response to determining weights and/or connections in the MDN layer 406 that result in a small (i.e., minimal) error for the particular user, the machine learning model architecture 400 can be utilized to generate digitized handwriting corresponding to input writing or text based on the handwriting style of the user.

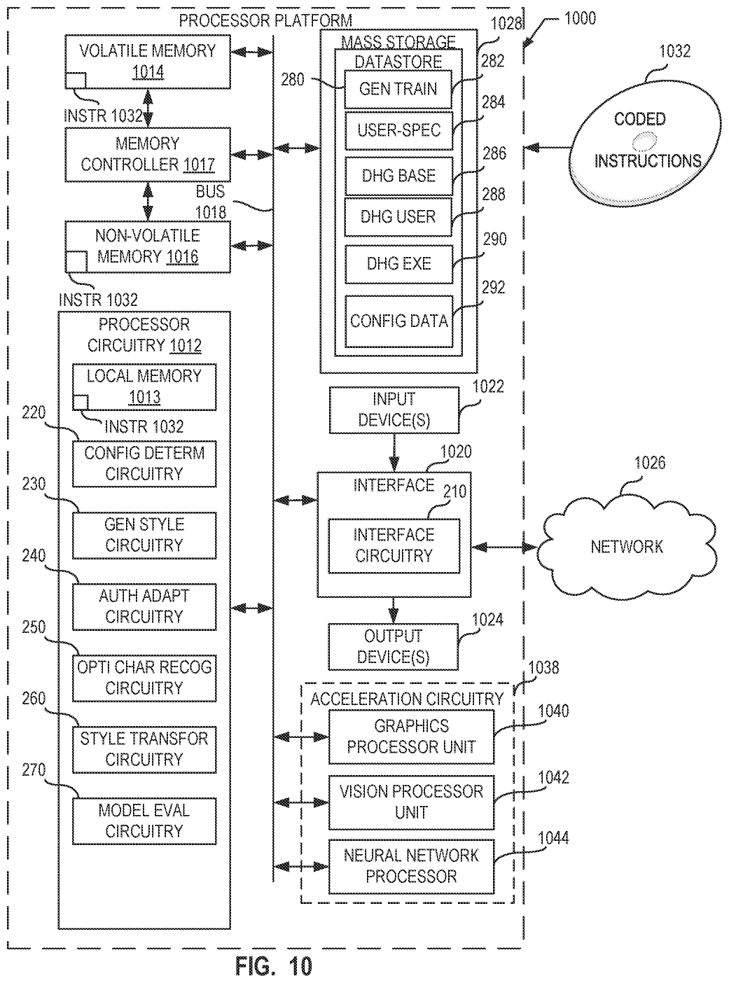

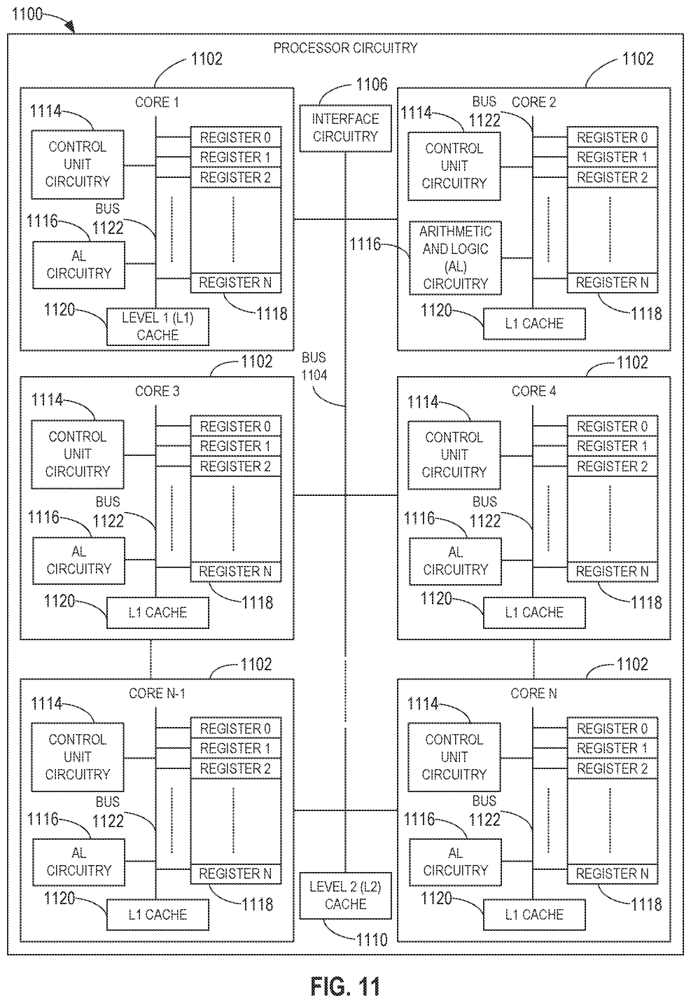

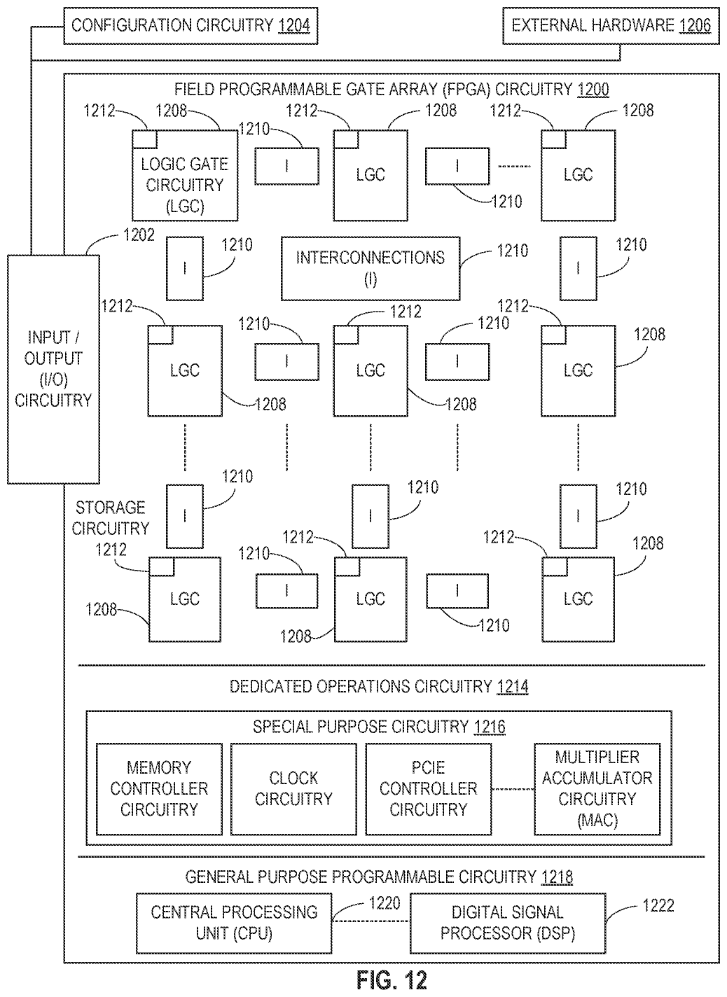

In some examples, the handwriting generation circuitry 104A-E includes first means for training a machine learning model to generate at least a first digitized handwriting sequence based on at least one handwriting sample in at least one handwriting dataset. For example, the first means for training may be implemented by the generalized style generation circuitry 230. In some examples, the generalized style generation circuitry 230 may be instantiated by processor circuitry such as the example processor circuitry 1012 of FIG. 10. For instance, the generalized style generation circuitry 230 may be instantiated by the example microprocessor 1100 of FIG. 11 executing machine executable instructions such as those implemented by at least blocks 502, 504, 506, 508, 510, 512, 514, 516, 518, 520 of FIG. 5. In some examples, the generalized style generation circuitry 230 may be instantiated by hardware logic circuitry, which may be implemented by an ASIC, XPU, or the FPGA circuitry 1200 of FIG. 12 structured to perform operations corresponding to the aforementioned machine executable instructions of FIG. 5. Additionally or alternatively, the generalized style generation circuitry 230 may be instantiated by any other combination of hardware, software, and/or firmware. For example, the generalized style generation circuitry 230 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the handwriting generation circuitry 104A-E includes second means for training the machine learning model to generate at least a second digitized handwriting sequence based on a user handwriting sample. In some examples, the second means for training is to maintain a first portion of the machine learning model configured by the first means for training and modify a second portion of the machine learning model using model-agnostic meta-learning. For example, the second means for training may be implemented by the author adaptation circuitry 240. In some examples, the author adaptation circuitry 240 may be instantiated by processor circuitry such as the example processor circuitry 1012 of FIG. 10. For instance, the author adaptation circuitry 240 may be instantiated by the example microprocessor 1100 of FIG. 11 executing machine executable instructions such as those implemented by at least blocks 602, 604, 606, 608 of FIG. 6. In some examples, the author adaptation circuitry 240 may be instantiated by hardware logic circuitry, which may be implemented by an ASIC, XPU, or the FPGA circuitry 1200 of FIG. 12 structured to perform operations corresponding to the aforementioned machine executable instructions of FIG. 6. Additionally or alternatively, the author adaptation circuitry 240 may be instantiated by any other combination of hardware, software, and/or firmware. For example, the author adaptation circuitry 240 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

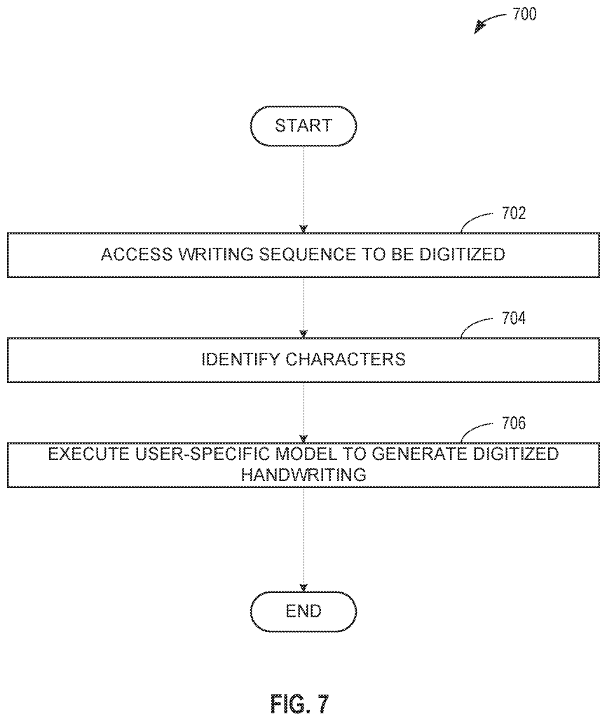

In some examples, the handwriting generation circuitry 104A-E means for implementing a machine learning model, such as the DHG model 124 of FIG. 1, the DHG base model 286 of FIG. 2, the DHG user-specific model 288 of FIG. 2, and/or the machine learning model architecture 400. For example, the means for implementing the machine learning model may be implemented by the style transformation circuitry 260. In some examples, the style transformation circuitry 260 may be instantiated by processor circuitry such as the example processor circuitry 1012 of FIG. 10. For instance, the style transformation circuitry 260 may be instantiated by the example microprocessor 1100 of FIG. 11 executing machine executable instructions such as those implemented by at least blocks 702, 704, 706 of FIG. 7. In some examples, the style transformation circuitry 260 may be instantiated by hardware logic circuitry, which may be implemented by an ASIC, XPU, or the FPGA circuitry 1200 of FIG. 12 structured to perform operations corresponding to the aforementioned machine executable instructions of FIG. 7. Additionally or alternatively, the style transformation circuitry 260 may be instantiated by any other combination of hardware, software, and/or firmware. For example, the style transformation circuitry 260 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the handwriting generation circuitry 104A-E of FIG. 1 is illustrated in FIG. 2, one or more of the elements, processes, and/or devices illustrated in FIG. 2 may be combined, divided, re-arranged, omitted, eliminated, and/or implemented in any other way. Further, the example bus 205, the example interface circuitry 210, the example configuration determination circuitry 220, the example generalized style generation circuitry 230, the example author adaptation circuitry 240, the example optical character recognition circuitry 250, the example style transformation circuitry 260, the example model evaluation circuitry 270, the example datastore 280, and/or, more generally, the example handwriting generation circuitry 104A-E of FIG. 1, may be implemented by hardware alone or by hardware in combination with software and/or firmware. Thus, for example, any of the example bus 205, the example interface circuitry 210, the example configuration determination circuitry 220, the example generalized style generation circuitry 230, the example author adaptation circuitry 240, the example optical character recognition circuitry 250, the example style transformation circuitry 260, the example model evaluation circuitry 270, the example datastore 280, and/or, more generally, the example handwriting generation circuitry 104A-E, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example handwriting generation circuitry 104A-E of FIG. 1 may include one or more elements, processes, and/or devices in addition to, or instead of, those illustrated in FIG. 2, and/or may include more than one of any or all of the illustrated elements, processes and devices.

Flowcharts representative of example machine readable instructions, which may be executed to configure processor circuitry to implement the handwriting generation circuitry 104A-E of FIGS. 1-4, are shown in FIGS. 5-8. The machine readable instructions may be one or more executable programs or portion(s) of an executable program for execution by processor circuitry, such as the processor circuitry 1012 shown in the example processor platform 1000 discussed below in connection with FIG. 10 and/or the example processor circuitry discussed below in connection with FIGS. 11 and/or 12. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 5-8, many other methods of implementing the example handwriting generation circuitry 104A-E may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 5-8 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 5 is a flowchart representative of example machine readable instructions and/or example operations 500 that may be executed and/or instantiated by processor circuitry to train a machine learning model to generate digitized handwriting for general handwriting styles. The machine readable instructions and/or the operations 500 of FIG. 5 begin at block 502, at which the handwriting generation circuitry 104A-E imports training data. For example, the interface circuitry 210 (FIG. 2) can access and/or record the general training data 282 (FIG. 2), which can include publicly available handwriting datasets, such as the IAM On-Line Handwriting Database. In some examples, the interface circuitry 114 (FIG. 1) of the electronic system 102 (FIG. 1) access a first portion of the training data 122 (FIG. 1) via the network 128. For example, the interface circuitry 114 can download and/or access the IAM On-Line Handwriting Database via the Internet.

At block 504, the handwriting generation circuitry 104A-E identifies a handwriting sequence to digitize. For example, the handwriting generation circuitry 104A-E can execute the DHG model 124 with a portion of the training data 122 as an input. Specifically, the portion of the training data 122 can include vectors corresponding to a sequence of handwritten words, numbers, and/or symbols. In some examples, the configuration determination circuitry 220 (FIG. 2) triggers the generalized style generation circuitry 230 (FIG. 2) to run the DHG base model 286 (FIG. 2) with a handwriting sequence from the general training data 282 as an input in response to identifying and/or determining that the DHG base model 286 (FIG. 2) in the datastore 280 (FIG. 2) has not yet been trained. In turn, the generalized style generation circuitry 230 can cause the handwriting sequence from the general training data 282 to serve as the input sequence vectors 416 (FIG. 4) in the attention layer 402 (FIG. 4) of the machine learning model architecture 400. In some examples, the feature extractor 320 (FIG. 3) and/or the attention network 322 (FIG. 3) identifies the handwriting sequence in the online handwriting sequence data corpus 316 and/or the one-hot representation of character sets database 318 in the training dataset 306 (FIG. 3).

At block 506, the handwriting generation circuitry 104A-E identifies characters in the handwriting sequence. For example, the handwriting generation circuitry 104A-E can determine characters in the handwriting sequence based on a one-hot vector associated with the handwriting sequence in the portion of the training data 122. In some examples, the generalized style generation circuitry 230 identifies the one-hot vector indicative of ASCII characters in the handwriting sequence in the general training data 282. In turn, the example generalized style generation circuitry 230 can cause the one-hot vector to serve as the one-hot vector 418 (FIG. 4) in the attention layer 402 of the machine learning model architecture 400. In some examples, the attention network 322 identifies the one-hot representation of the handwriting sequence in the one-hot representation of character sets database 318.

At block 508, the handwriting generation circuitry 104A-E learns features of the characters in the handwriting sequence. For example, the generalized style generation circuitry 230 can cause execution of the DHG base model 286 with the handwriting sequence and characters as inputs to cause the DHG baser model 286 to identify and/or learn features of the characters in the handwriting sequence. In some examples, the sequence generation layer 404 (FIG. 4) identifies and/or learns features of the characters in the handwriting sequence. For example, the first LSTM 420 (FIG. 4), the second LSTM 424 (FIG. 4), and/or the third LSTM 426 (FIG. 4) can identify and/or learn digital ink coordinates associated with the characters in the handwriting sequence. In some examples, the feature extractor 320 determines features associated with encountered characters. In turn, the example feature extractor 320 can indicate the features to the example sequence-to-sequence generator network 324 (FIG. 3), and the attention network 322 can indicate the character to the sequence-to-sequence generator network 324 such that the sequence-to-sequence generator network 324 can associated the features with the corresponding character.

At block 510, the handwriting generation circuitry 104A-E generates coordinates for digital ink points in the handwriting sequence. For example, the generalized style generation circuitry 230 can cause execution of the DHG base model 286 to generate the coordinates for the digital ink points corresponding to ink of the characters in the handwriting sequence. In some examples, the first LSTM 420, the second LSTM 424, and/or the third LSTM 426 generate the coordinates as a displacement from a previously generated coordinate. The window layer 422 (FIG. 4) directs the first LSTM 420, the second LSTM 424, and/or the third LSTM 426 to generate the coordinates for different characters in the handwriting sequence. In some examples, the sequence-to-sequence generator network 324 generates the coordinates based on the features identified by the features extractor 320 and the corresponding characters identified by the sequence-to-sequence generator network 324.

At block 512, the handwriting generation circuitry 104A-E distributes the coordinates to generate a digitized handwriting sequence. For example, the generalized style generation circuitry 230 can cause execution of the DHG base model 286 to distribute the generated coordinates to put together words and/or sentences in the handwriting sequence. In some examples, the MDN layer 406 (FIG. 4) determines a distribution of the coordinates generated by the sequence generation layer 404. As such, the MDN layer 406 can generate the sequence prediction vectors 414 (FIG. 4). In some examples, the sequence-to-sequence generator network 324 learns a distribution of the coordinates based on the character(s) being generated.

At block 514, the handwriting generation circuitry 104A-E computes an error of the digitized handwriting sequence relative to the original handwriting sequence. For example, the generalized style generation circuitry 230 can cause execution of the DHG base model 286 to cause the error to be computed using Equation (1). In some examples, the reparameterization layer 408 computes the MDN loss and the MSE between the sequence prediction vectors 414 and the input sequence vectors 416. Specifically, the MSE can be indicative of a difference between the generated coordinates and coordinates of ink points in the input handwriting sequence. The MDN loss can be indicative of a difference between the distribution of the generated coordinates for the characters in the digitized handwriting sequence and the distribution of the coordinates for the characters in the input handwriting sequence. Further, the reparameterization layer 408 can apply weights to the MDN loss and the MSE, respectively, using the hyperparameter, λ, as shown in Equation (1). In some examples, the reparameterization layer 408 provides a first weight (e.g., 0.2) to the MSE and a second weight (e.g., 0.8) to the MDN loss. Accordingly, the reparameterization layer 408 can compute the weighted sum of the MSE and the MDN loss to determine the overall error between the input handwriting sequence and the digitized handwriting sequence.

At block 516, the handwriting generation circuitry 104A-E determines whether to advance the DHG model 124 to user-specific training. For example, the generalized style generation circuitry 230 can determine the DHG base model 286 is set and, thus, a general style training is complete in response to the error being minimized and/or satisfying a threshold. In some examples, the generalized style generation circuitry 230 determines the general style training is complete in response to utilizing all of the general training data 282 as inputs during iterations of executing the DHG base model 286. In response to the generalized style generation circuitry 230 determining not to advance to the user-specific training, the operations 500 proceed to block 518. Otherwise, the operations terminate.

At block 518, the handwriting generation circuitry 104A-E parameterizes the DHG model 124. For example, generalized style generation circuitry 230 can cause execution of the DHG base model 286 to cause a parameterization of a coordinate generation process associated with generating the coordinates for the digitized handwriting (e.g., at block 510). In some examples, the MDN layer 406 modifies weights and/or connections in the sequence generation layer 404 to parameterize the coordinate generation process based on the computed error.

At block 520, the handwriting generation circuitry 104A-E reparameterizes the DHG model 124. For example, the generalized style generation circuitry 230 can cause execution of the DHG base model 286 to cause a reparameterization of a coordinate distribution process. In some examples, the reparameterization layer 408 modifies weights and/or connections in the MDN layer 406 to reparameterize the coordinate distribution process based on the computed error. In some examples, the reparameterization layer 408 performs a first reparameterization of mixture components utilized to generate the distribution of the coordinates and a second reparameterization of categorically distributed mixture weights. In response to performing the reparameterization of the DHG model 124, the operations 500 return to block 504.

FIG. 6 is a flowchart representative of example machine readable instructions and/or example operations 600 that may be executed and/or instantiated by processor circuitry to train a machine learning model to generate digitized handwriting in a user-specific style. The machine readable instructions and/or the operations 600 of FIG. 6 begin at block 602, at which the handwriting generation circuitry 104A-E (FIGS. 1-4) accesses user-specific training data. For example, the handwriting generation circuitry 104A-E can receive a portion of the training data 122 from the user interface circuitry 126 (FIG. 1). In some examples, the interface circuitry 210 (FIG. 2) retrieves the user-specific training data 284 from the user interface circuitry 126 and/or stores the user-specific training data 284 in the datastore 280.

At block 604, the handwriting generation circuitry 104A-E identifies hyperparameters associated with few-shot learning. For example, the handwriting generation circuitry 104A-E can identify the hyperparameters in the DHG model 124. In some examples, the configuration determination circuitry 220 (FIG. 2) identifies the hyperparameters associated with few-shot learning in the configuration data 292 (FIG. 2). In some examples, the hyperparameters in the configuration data 292 are empirically selected based on a learning rate, a batch size, a number of training steps, etc. In some examples, the author adaptation circuitry 240 configures the DHG user-specific model 288 based on the hyperparameters and/or the DHG base model 286 configured based on the operations 500 of FIG. 5. For example, the author adaptation circuitry 240 can create a copy of the DHG base model 286 and configure the hyperparameters associated with few-shot learning to form the DHG user-specific model 288

At block 606, the handwriting generation circuitry 104A-E generates digitized handwriting corresponding to the user-specific training data. For example, the handwriting generation circuitry 104A-E can cause execution of the DHG model 124 using the portion of the training data 122 as an input to generate the digitized handwriting. In some examples, the author adaptation circuitry 240 causes execution of the DHG user-specific model 288 with the user-specific training data 284 as an input to generate the digitized handwriting.

At block 608, the handwriting generation circuitry 104A-E causes a reparameterization of the machine learning model based on the handwriting style of the particular user using few gradient descent steps. For example, the handwriting generation circuitry 104A-E can cause execution of the DHG model 124 using the portion of the training data 122 as an input to cause a first portion of the DHG model 124 to cause reparameterization of a second portion of the DHG model 124 while a third portion of the DHG model 124 remains fixed. In some examples, the author adaptation circuitry 240 causes execution of the DHG user-specific model 288 with the user-specific training data 284 as an input to cause the reparameterization layer 408 to reparameterize the MDN layer 406 while the sequence generation layer 404 remains fixed (e.g., remains the same as in the DHG base model 286). In some examples, the author adaptation circuitry 240 causes a few cycles of reparameterization to occur by causing execution of the DHG user-specific model 288 a few times with the user-specific training data 284 as the input to parameters associated with a minimal error to be determined using few gradient descent steps. That is, the reparameterization layer 408 can modify the weights and/or connections in the MDN layer 406 more than once to test different weights and/or connections and identify parameters associated with the lowest error for the style displayed by the user.

FIG. 7 is a flowchart representative of example machine readable instructions and/or example operations 700 that may be executed and/or instantiated by processor circuitry to generate digitized handwriting in a user-specific style. The machine readable instructions and/or the operations 700 of FIG. 7 begin at block 702, at which the handwriting generation circuitry 104A-E (FIGS. 1-4) accesses a writing sequence to be digitized. For example, the handwriting generation circuitry 104A-E can receive data corresponding to writing in any format received at the user interface circuitry 126 (FIG. 1). In some examples, the interface circuitry 210 (FIG. 2) accesses the writing.

At block 704, the handwriting generation circuitry 104A-E identifies characters in the writing sequence. For example, in response to the writing being an in image format or a handwritten format, the optical character recognition circuitry 250 (FIG. 2) can utilize optical character recognition to identify characters in the writing sequence. In some examples, the interface circuitry 210 and/or the optical character recognition circuitry 250 communicates the characters in the handwriting sequence to the style transformation circuitry 260 (FIG. 2).

At block 706, the handwriting generation circuitry 104A-E executes the user-specific DHG model 288 to generate digitized handwriting corresponding to the writing sequence. For example, the style transformation circuitry 260 can convert the DHG user-specific model 288 (FIG. 2) to the DHG executable 290 (FIG. 2). In turn, the style transformation circuitry 260 can execute the DHG executable 290 with the characters of the writing sequence as an input to obtain digitized handwriting corresponding to the writing sequence as an output. In some examples, the style transformation circuitry 260 causes the DHG executable 290 to output the digitized handwriting in an SVGZ format such that the digitized writing occupies a relatively small amount of storage space and is scalable without impacting resolution.

FIG. 8 is a flowchart representative of example machine readable instructions and/or example operations 800 that may be executed and/or instantiated by processor circuitry to evaluate digitized handwriting with respect to original handwriting. The machine readable instructions and/or the operations 800 of FIG. 8 begin at block 802, at which the handwriting generation circuitry 104A-E (FIGS. 1-4) extracts feature of an original handwriting sequence and a digitized handwriting sequence. For example, the digitized handwriting sequence can be generated by the handwriting generation circuitry 104A-E. For example, the model evaluation circuitry 270 (FIG. 2) can include and/or utilize a feature extractor to extract features in the digitized handwriting and the original handwriting.

At block 804, the handwriting generation circuitry 104A-E identifies which extracted features are important for a classification of the writings. For example, the model evaluation circuitry 270 can include and/or utilize a convolutional neural network (CNN) to identify the important features that have an impact on a similarity classification between the writings. An important feature is a feature that is used in the example operations 800 to identify a character of the writing. For example, an important feature may be a feature and/or a combination of features that is unique to a particular letter, number, symbol, and/or other text. An important feature may be a feature and/or a combination of features indicative of a writing style, a language, a writing direction, etc. Different features of words, letters, numbers, symbols, and/or other text may be defined as important in different contexts or processes. Any feature of writing useful in classification of the writing may be an important feature.

At block 806, the handwriting generation circuitry 104A-E computes a cosine similarity between the important features of the original handwriting sequence and the digitized handwriting sequence. For example, the model evaluation circuitry 270 can compute the cosine similarity of the important features.

At block 808, the handwriting generation circuitry 104A-E determines whether a similarity threshold is satisfied. For example, the model evaluation circuitry 270 can compare the cosine similarity to the similarity threshold. In response to the cosine similarity satisfying (e.g., being greater than) the similarity threshold, the operations 800 proceed to block 810. Otherwise, in response to the cosine similarity not satisfying (e.g., being less than) the similarity threshold, the operations 800 proceed to block 812.

At block 810, the handwriting generation circuitry 104A-E classifies the digitized handwriting sequence as matching the original handwriting sequence. For example, the model evaluation circuitry 270 can classify the original and digitized handwriting sequences as a match in response to the cosine similarity threshold being satisfied.

At block 812, the handwriting generation circuitry 104A-E classifies the digitized handwriting sequence as different from the original handwriting sequence. For example, the model evaluation circuitry 270 can classify the original and digitized handwriting sequences as different in response to the cosine similarity threshold not being satisfied.

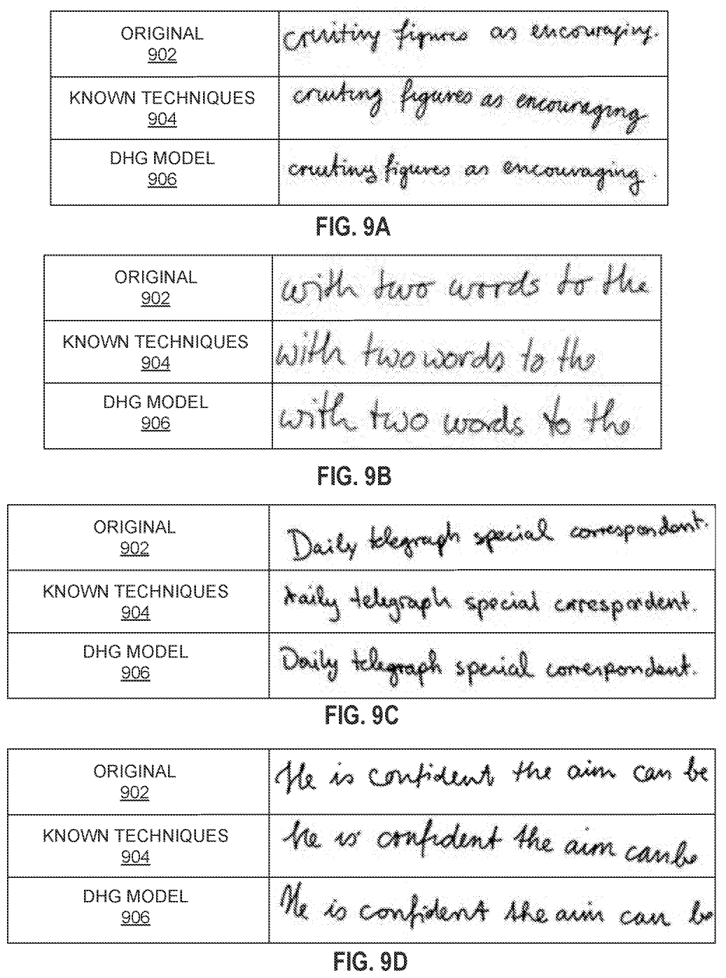

FIGS. 9A-D illustrate original handwriting sequences 902 in comparison with prior art generated handwriting 904 (identified by KNOWN TECHNIQUES) and example digitized handwriting 906 (identified by DHG MODEL) generated by the handwriting generation circuitry 104A-E of FIGS. 1-4 in accordance with teachings disclosed herein. As shown in the illustrated example, the MSE in the loss function of Equation (1) enables the example digitized handwriting 906 to maintain a horizontal alignment. Thus, the handwriting generation circuitry 104A-E prevents a downtrend from occurring in the digitized handwriting 906, such as the downtrend produced in the prior art generated handwriting 904 in at least FIGS. 9A and 9C. Furthermore, the handwriting generation circuitry 104A-E enables character styles of the original handwriting sequences 902 to be better captured in the digitized handwriting 906 compared to the prior art generated handwriting 904 (e.g., see the first letter (“D”) in FIG. 9C). Moreover, the handwriting generation circuitry 104A-E enables cursive in the original handwriting 902 to be better captured in the digitized handwriting 906 compared to the prior art generated handwriting 904 (e.g., see the connection between the first letters (“wi”) in FIG. 9B).

FIG. 10 is a block diagram of an example processor platform 1000 structured to execute and/or instantiate the machine readable instructions and/or the operations of FIGS. 5-8 to implement the handwriting generation circuitry 104A-E of FIGS. 1-4. The processor platform 1000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1000 of the illustrated example includes processor circuitry 1012. The processor circuitry 1012 of the illustrated example is hardware. For example, the processor circuitry 1012 can be implemented by one or more integrated circuits, logic circuits, FPGAs, microprocessors, CPUs, GPUs, DSPs, and/or microcontrollers from any desired family or manufacturer. The processor circuitry 1012 may be implemented by one or more semiconductor based (e.g., silicon based) devices. In this example, the processor circuitry 1012 implements the example configuration determination circuitry 220, the example generalized style generation circuitry 230, the example author adaptation circuitry 240, the example optical character recognition circuitry 250, the example style transformation circuitry 260, and the example model evaluation circuitry 270.

The processor circuitry 1012 of the illustrated example includes a local memory 1013 (e.g., a cache, registers, etc.). The processor circuitry 1012 of the illustrated example is in communication with a main memory including a volatile memory 1014 and a non-volatile memory 1016 by a bus 1018. The volatile memory 1014 may be implemented by Synchronous Dynamic Random Access Memory (SDRAM), Dynamic Random Access Memory (DRAM), RAIVIBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017.

The processor platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In this example, the interface circuitry 1020 implements the interface circuitry 210 of FIG. 2.

In the illustrated example, one or more input devices 1022 are connected to the interface circuitry 1020. The input device(s) 1022 permit(s) a user to enter data and/or commands into the processor circuitry 1012. The input device(s) 1022 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1024 are also connected to the interface circuitry 1020 of the illustrated example. The output device(s) 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1000 of the illustrated example also includes one or more mass storage devices 1028 to store software and/or data. Examples of such mass storage devices 1028 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 1032, which may be implemented by the machine readable instructions of FIGS. 5-8, may be stored in the mass storage device 1028, in the volatile memory 1014, in the non-volatile memory 1016, and/or on a removable non-transitory computer readable storage medium such as a CD or DVD. In this example, the mass storage device 1028 includes the example datastore 280 including the example general training data 282, the example user-specific training data 284, the example DHG base model 286, the example DHG user-specific model 288, the example DHG executable 290, and the example configuration data 292.

The processor platform 1000 of the illustrated example of FIG. 10 includes example acceleration circuitry 1038, which includes an example graphics processing unit (GPU) 1040, an example vision processing unit (VPU) 1042, and an example neural network processor 1044. In this example, the GPU 1040, the VPU 1042, and the neural network processor 1044 are in communication with different hardware of the processor platform 1000, such as the volatile memory 1014, the non-volatile memory 1016, etc., via the bus 1018. In this example, the neural network processor 1044 may be implemented by one or more integrated circuits, logic circuits, microprocessors, GPUs, DSPs, or controllers from any desired family or manufacturer that can be used to execute an AI model, such as a neural network, which may be implemented by the DHG base model 286 and/or the DHG user-specific model 288. In some examples, one or more of the example configuration determination circuitry 220, the example generalized style generation circuitry 230, the example author adaptation circuitry 240, the example optical character recognition circuitry 250, the example style transformation circuitry 260, and/or the example model evaluation circuitry 270 can be implemented in or with at least one of the GPU 1040, the VPU 1042, or the neural network processor 1044 instead of or in addition to the processor circuitry 1012.

In some examples, the GPU 1040 may implement the first hardware accelerator 108, the second hardware accelerator 110, and/or the general purpose processor circuitry 112 of FIG. 1. In some examples, the VPU 1042 may implement the first hardware accelerator 108, the second hardware accelerator 110, and/or the general purpose processor circuitry 112 of FIG. 1. In some examples, the neural network processor 1044 may implement the first hardware accelerator 108, the second hardware accelerator 110, and/or the general purpose processor circuitry 112 of FIG. 1.

FIG. 11 is a block diagram of an example implementation of the processor circuitry 1012 of FIG. 10. In this example, the processor circuitry 1012 of FIG. 10 is implemented by a microprocessor 1100. For example, the microprocessor 1100 may be a general purpose microprocessor (e.g., general purpose microprocessor circuitry). The microprocessor 1100 executes some or all of the machine readable instructions of the flowcharts of FIGS. 5-8 to effectively instantiate the handwriting generation circuitry 104A-E of FIGS. 1-4 as logic circuits to perform the operations corresponding to those machine readable instructions. In some such examples, the handwriting generation circuitry 104A-E of FIGS. 1-4 is instantiated by the hardware circuits of the microprocessor 1100 in combination with the instructions. For example, the microprocessor 1100 may be implemented by multi-core hardware circuitry such as a CPU, a DSP, a GPU, an XPU, etc. Although it may include any number of example cores 1102 (e.g., 1 core), the microprocessor 1100 of this example is a multi-core semiconductor device including N cores. The cores 1102 of the microprocessor 1100 may operate independently or may cooperate to execute machine readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion or all of the machine readable instructions and/or operations represented by the flowcharts of FIGS. 5-8.

The cores 1102 may communicate by a first example bus 1104. In some examples, the first bus 1104 may be implemented by a communication bus to effectuate communication associated with one(s) of the cores 1102. For example, the first bus 1104 may be implemented by at least one of an Inter-Integrated Circuit (I2C) bus, a Serial Peripheral Interface (SPI) bus, a PCI bus, or a PCIe bus. Additionally or alternatively, the first bus 1104 may be implemented by any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory 1120 (e.g., Level 1 (L1) cache that may be split into an L1 data cache and an L1 instruction cache), the microprocessor 1100 also includes example shared memory 1110 that may be shared by the cores (e.g., Level 2 (L2 cache)) for high-speed access to data and/or instructions. Data and/or instructions may be transferred (e.g., shared) by writing to and/or reading from the shared memory 1110. The local memory 1120 of each of the cores 1102 and the shared memory 1110 may be part of a hierarchy of storage devices including multiple levels of cache memory and the main memory (e.g., the main memory 1014, 1016 of FIG. 10). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1102 may be referred to as a CPU, DSP, GPU, etc., or any other type of hardware circuitry. Each core 1102 includes control unit circuitry 1114, arithmetic and logic (AL) circuitry (sometimes referred to as an ALU) 1116, a plurality of registers 1118, the local memory 1120, and a second example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer based operations. In other examples, the AL circuitry 1116 also performs floating point operations. In yet other examples, the AL circuitry 1116 may include first AL circuitry that performs integer based operations and second AL circuitry that performs floating point operations. In some examples, the AL circuitry 1116 may be referred to as an Arithmetic Logic Unit (ALU). The registers 1118 are semiconductor-based structures to store data and/or instructions such as results of one or more of the operations performed by the AL circuitry 1116 of the corresponding core 1102. For example, the registers 1118 may include vector register(s), SIMD register(s), general purpose register(s), flag register(s), segment register(s), machine specific register(s), instruction pointer register(s), control register(s), debug register(s), memory management register(s), machine check register(s), etc. The registers 1118 may be arranged in a bank as shown in FIG. 11. Alternatively, the registers 1118 may be organized in any other arrangement, format, or structure including distributed throughout the core 1102 to shorten access time. The second bus 1122 may be implemented by at least one of an I2C bus, a SPI bus, a PCI bus, or a PCIe bus

Each core 1102 and/or, more generally, the microprocessor 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1100 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 12 is a block diagram of another example implementation of the processor circuitry 1012 of FIG. 10. In this example, the processor circuitry 1012 is implemented by FPGA circuitry 1200. For example, the FPGA circuitry 1200 may be implemented by an FPGA. The FPGA circuitry 1200 can be used, for example, to perform operations that could otherwise be performed by the example microprocessor 1100 of FIG. 11 executing corresponding machine readable instructions. However, once configured, the FPGA circuitry 1200 instantiates the machine readable instructions in hardware and, thus, can often execute the operations faster than they could be performed by a general purpose microprocessor executing the corresponding software.

More specifically, in contrast to the microprocessor 1100 of FIG. 11 described above (which is a general purpose device that may be programmed to execute some or all of the machine readable instructions represented by the flowcharts of FIGS. 5-8 but whose interconnections and logic circuitry are fixed once fabricated), the FPGA circuitry 1200 of the example of FIG. 12 includes interconnections and logic circuitry that may be configured and/or interconnected in different ways after fabrication to instantiate, for example, some or all of the machine readable instructions represented by the flowcharts of FIGS. 5-8. In particular, the FPGA circuitry 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the software represented by the flowcharts of FIGS. 5-8. As such, the FPGA circuitry 1200 may be structured to effectively instantiate some or all of the machine readable instructions of the flowcharts of FIGS. 5-8 as dedicated logic circuits to perform the operations corresponding to those software instructions in a dedicated manner analogous to an ASIC. Therefore, the FPGA circuitry 1200 may perform the operations corresponding to the some or all of the machine readable instructions of FIGS. 5-8 faster than the general purpose microprocessor can execute the same.

In the example of FIG. 12, the FPGA circuitry 1200 is structured to be programmed (and/or reprogrammed one or more times) by an end user by a hardware description language (HDL) such as Verilog. The FPGA circuitry 1200 of FIG. 12, includes example input/output (I/O) circuitry 1202 to obtain and/or output data to/from example configuration circuitry 1204 and/or external hardware 1206. For example, the configuration circuitry 1204 may be implemented by interface circuitry that may obtain machine readable instructions to configure the FPGA circuitry 1200, or portion(s) thereof. In some such examples, the configuration circuitry 1204 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1206 may be implemented by external hardware circuitry. For example, the external hardware 1206 may be implemented by the microprocessor 1100 of FIG. 11. The FPGA circuitry 1200 also includes an array of example logic gate circuitry 1208, a plurality of example configurable interconnections 1210, and example storage circuitry 1212. The logic gate circuitry 1208 and the configurable interconnections 1210 are configurable to instantiate one or more operations that may correspond to at least some of the machine readable instructions of FIGS. 5-8 and/or other desired operations. The logic gate circuitry 1208 shown in FIG. 12 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations. The logic gate circuitry 1208 may include other electrical structures such as look-up tables (LUTs), registers (e.g., flip-flops or latches), multiplexers, etc.

The configurable interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 12 also includes example Dedicated Operations Circuitry 1214. In this example, the Dedicated Operations Circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 11 and 12 illustrate two example implementations of the processor circuitry 1012 of FIG. 10, many other approaches are contemplated. For example, as mentioned above, modern FPGA circuitry may include an on-board CPU, such as one or more of the example CPU 1220 of FIG. 12. Therefore, the processor circuitry 1012 of FIG. 10 may additionally be implemented by combining the example microprocessor 1100 of FIG. 11 and the example FPGA circuitry 1200 of FIG. 12. In some such hybrid examples, a first portion of the machine readable instructions represented by the flowcharts of FIGS. 5-8 may be executed by one or more of the cores 1102 of FIG. 11, a second portion of the machine readable instructions represented by the flowcharts of FIGS. 5-8 may be executed by the FPGA circuitry 1200 of FIG. 12, and/or a third portion of the machine readable instructions represented by the flowchart of FIGS. 5-8 may be executed by an ASIC. It should be understood that some or all of the handwriting generation circuitry 104A-E of FIGS. 1-4 may, thus, be instantiated at the same or different times. Some or all of the circuitry may be instantiated, for example, in one or more threads executing concurrently and/or in series. Moreover, in some examples, some or all of the handwriting generation circuitry 104A-E of FIGS. 1-4 may be implemented within one or more virtual machines and/or containers executing on the microprocessor.

In some examples, the processor circuitry 1012 of FIG. 10 may be in one or more packages. For example, the microprocessor 1100 of FIG. 11 and/or the FPGA circuitry 1200 of FIG. 12 may be in one or more packages. In some examples, an XPU may be implemented by the processor circuitry 1012 of FIG. 10, which may be in one or more packages. For example, the XPU may include a CPU in one package, a DSP in another package, a GPU in yet another package, and an FPGA in still yet another package.

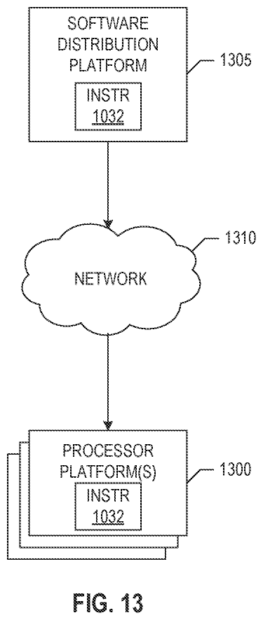

A block diagram illustrating an example software distribution platform 1305 to distribute software such as the example machine readable instructions 1032 of FIG. 10 to hardware devices owned and/or operated by third parties is illustrated in FIG. 13. The example software distribution platform 1305 may be implemented by any computer server, data facility, cloud service, etc., capable of storing and transmitting software to other computing devices. The third parties may be customers of the entity owning and/or operating the software distribution platform 1305. For example, the entity that owns and/or operates the software distribution platform 1305 may be a developer, a seller, and/or a licensor of software such as the example machine readable instructions 1032 of FIG. 10. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the machine readable instructions 1032, which may correspond to the example machine readable instructions 500, 600, 700, 800 of FIGS. 5-8, as described above. The one or more servers of the example software distribution platform 1305 are in communication with an example network 1310, which may correspond to any one or more of the Internet and/or any of the example networks 128, 1026 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1032 from the software distribution platform 1305. For example, the software, which may correspond to the example machine readable instructions 1032 of FIG. 10, may be downloaded to the example processor platform 1300, which is to execute the machine readable instructions 1032 to implement the handwriting generation circuitry 104A-E. In some examples, one or more servers of the software distribution platform 1305 periodically offer, transmit, and/or force updates to the software (e.g., the example machine readable instructions 1032 of FIG. 10) to ensure improvements, patches, updates, etc., are distributed and applied to the software at the end user devices.

From the foregoing, it will be appreciated that example systems, methods, apparatus, and articles of manufacture have been disclosed that generate digitized handwriting with style adaptations specific to the unique handwriting styles of different users. In addition, to many benefits disclosed above, example systems, methods, apparatus, and articles of manufacture disclosed herein are agnostic to language, alphabet, and writing direction (e.g., left to right, right to left, top to bottom). Thus, examples disclosed herein are useful in many applications throughout the world.

Additionally, example systems, methods, apparatus, and articles of manufacture disclosed herein can be utilized in conjunction with a speech detection system to generate digitized handwriting in a style of user based on detected spoken words. For example, when the speech detection system detects words spoken by a user, the example systems, methods, apparatus, and articles of manufacture disclosed herein can generate digitized handwriting indicative of the words in a user-specific style. In some examples, the user-specific style of the digitized handwriting is attributable to a voice through which the spoken words are presented. For instance, when a professor gives a lecture, an electronic device of the user can detect a voice of the professor and generate digitized handwriting in a style specific to the professor. In some other examples, the user-specific style of the digitized handwriting is agnostic to the voice through which the spoken words are presented. For example, when the professor gives the lecture, the electronic device of the user can generate digitized handwriting corresponding to the spoken words in a style specific to the user or in a style specific to a third party.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus to generate digitized handwriting with user style adaptations comprising:
at least one memory;
machine readable instructions; and
processor circuitry to at least one of instantiate or execute the machine readable instructions to:
train a machine learning model to generate a first digitized handwriting sequence based on a stored handwriting sample, to train the machine learning model, the processor circuitry to at least one instantiate or execute the machine readable instructions to:
cause a parameterization of a first portion of the machine learning model; and
cause a reparameterization of a second portion of the machine learning model;
re-train the trained machine learning model to generate a second digitized handwriting sequence based on a user handwriting sample; and
facilitate at least one of instantiation, deployment, or execution of the re-trained machine learning model.

2. The apparatus of claim 1, wherein the reparameterization is a first reparameterization, wherein, to re-train the machine learning model, the processor circuitry is to at least one of instantiate or execute the machine readable instructions to cause a second reparameterization of the second portion of the machine learning model utilizing gradient descent.

3. The apparatus of claim 1, wherein, to re-train the machine learning model, the processor circuitry is to at least one of instantiate or execute the machine readable instructions to:
adjust the second portion of the machine learning model; and
maintain the first portion of the machine learning model.

4. The apparatus of claim 1, wherein the second portion of the machine learning model determines the parameterization and a third portion of the machine learning model determines the reparameterization, wherein the first portion of the machine learning model is a mixture density network layer, the second portion of the machine learning model utilizes at least one long short-term memory, and the third portion of the machine learning model includes a reparameterization layer.

5. The apparatus of claim 1, wherein the reparameterization is based on an error computed using a loss function, the loss function including a mixture density network loss and a mean squared error between the first digitized handwriting sequence and the stored handwriting sample or between the second digitized handwriting sequence and the user handwriting sample.

6. The apparatus of claim 5, wherein the loss function includes a hyperparameter that applies a first weight to the mixture density network loss and a second weight to the mean squared error, the first weight greater than the second weight.

7. The apparatus of claim 1, wherein the user handwriting sample includes twenty or fewer words.

8. The apparatus of claim 1, wherein the processor circuitry is to at least one of instantiate or execute the machine readable instructions to execute the machine learning model to generate a third digitized handwriting sequence corresponding to an input in response to training and re-training the machine learning model.

9. At least one non-transitory machine readable storage medium comprising instructions that, when executed, cause processor circuitry to at least:
train a machine learning model to generate a first digitized handwriting sequence based on a handwriting sample in a handwriting dataset, to train the machine learning model, the instructions, when executed, cause the processor circuitry to:
compute a mixture density network loss between the first digitized handwriting sequence and the handwriting sample;
compute a mean squared error between at least the first digitized handwriting sequence and the handwriting sample;
determine an overall error of the first digitized handwriting sequence with respect to the handwriting sample based on the mixture density network loss and the mean squared error; and
modify the machine learning model based on the overall error; and
re-train the machine learning model to generate a second digitized handwriting sequence based on a user handwriting sample; and
facilitate at least one of instantiation, deployment, or execution of the machine learning model.

10. The at least one non-transitory machine readable storage medium of claim 9, wherein the instructions, when executed, cause the processor circuitry to:
apply a first weight to the mixture density network loss;
apply a second weight to the mean squared error; and
compute the overall error based on a sum of the mixture density network loss with the first weight and the mean squared error with the second weight.

11. The at least one non-transitory machine readable storage medium of claim 9, wherein to modify the machine learning model, the instructions, when executed, cause the processor circuitry to:
cause a parameterization of a first portion of the machine learning model; and
cause a reparameterization of a second portion of the machine learning model.

12. The at least one non-transitory machine readable storage medium of claim 11, wherein the reparameterization is a first reparameterization, wherein to re-train the machine learning model, the instructions, when executed, cause the processor circuitry to:
cause the first portion of the machine learning model to remain fixed; and
cause a second reparameterization of the second portion of the machine learning model.

13. The at least one non-transitory machine readable storage medium of claim 11, wherein the instructions, when executed, cause the processor circuitry to re-train the machine learning model using few-shot learning.

14. The at least one non-transitory machine readable storage medium of claim 9, wherein the user handwriting sample includes twenty or fewer words.

15. The at least one non-transitory machine readable storage medium of claim 9, wherein the instructions, when executed, cause the processor circuitry to execute the machine learning model to generate a third digitized handwriting sequence corresponding to an input in response to training and re-training the machine learning model.

16. An apparatus to generate digitized handwriting with user style adaptations comprising:
first means for training a machine learning model to generate a first digitized handwriting sequence based on a stored handwriting sample;
second means for training the machine learning model to generate a second digitized handwriting sequence based on a user handwriting sample, the second means for training to maintain a first portion of the machine learning model configured by the first means for training and modify a second portion of the machine learning model using model-agnostic meta-learning; and
means for implementing the machine learning model.

17. The apparatus of claim 16, wherein the first means for training is to:
compute a mixture density network loss between the first digitized handwriting sequence and the stored handwriting sample;
compute a mean squared error between the first digitized handwriting sequence and the stored handwriting sample;
determine an error of the first digitized handwriting sequence with respect to the stored handwriting sample based on the mixture density network loss and the mean squared error; and
modify the first portion of the machine learning model and the second portion of the machine learning model based on the error.

18. The apparatus of claim 16, wherein the first means for training causes a third portion of the machine learning model to backpropagate modifications to the second portion of the machine learning model and causes the second portion of the machine learning model to backpropagate modifications to the first portion of the machine learning model.

19. The apparatus of claim 18, wherein the first portion of the machine learning model utilizes at least one long short-term memory, the second portion of the machine learning model utilizes a mixture density network, and the third portion of the machine learning model utilizes a reparameterization layer.

20. The apparatus of claim 16, wherein the means for implementing the machine learning model is to execute the machine learning model to generate a third digitized handwriting sequence corresponding to an input in response to training and re-training the machine learning model.

21. A method to generate digitized handwriting with user style adaptations comprising:
training a machine learning model to generate a first digitized handwriting sequence based on a reference handwriting sample in a dataset;
re-training the machine learning model to generate a second digitized handwriting sequence based on a user handwriting sample, the re-training including:
fixing a first portion of the machine learning model in response to the training; and
modifying a second portion of the machine learning model utilizing gradient descent; and
facilitating at least one of instantiation, deployment, or execution of the machine learning model.

22. The method of claim 21, wherein training the machine learning model further includes:
computing a mixture density network loss between the first digitized handwriting sequence and the reference handwriting sample;
computing a mean squared error between the first digitized handwriting sequence and the reference handwriting sample; and
determining an error of the first digitized handwriting sequence with respect to the reference handwriting sample based on the mixture density network loss and the mean squared error.

23. The method of claim 21, wherein the training includes:
performing a parameterization of the first portion of the machine learning model; and
performing a reparameterization of the second portion of the machine learning model.

24. The method of claim 21, wherein the first portion of the machine learning model is to generate digital ink coordinates in the first digitized handwriting sequence and the second digitized handwriting sequence.

25. The method of claim 24, wherein the second portion of the machine learning model is to determine a distribution of the digital ink coordinates for the first digitized handwriting sequence and the second digitized handwriting sequence.
